(19) United States
(12) Patent Application Publication
(10) Pub. No.: US 2025/0292315 A1
(43) Pub. Date: Sep. 18, 2025

(54) MANAGEMENT SERVER AND MANAGEMENT SYSTEM

(71) Applicant: SEIKO EPSON CORPORATION, Tokyo (JP)

(72) Inventor: Takayuki SHIMIZU, SHIOJIRI-SHI (JP)

(21) Appl. No.: 19/078,387

(22) Filed: Mar. 13, 2025

(30) Foreign Application Priority Data
Mar. 14, 2024 (JP) 2024-039981

(51) Int. Cl. G06Q 30/0645

(52) U.S. Cl. CPC G06Q 30/0645

(57) ABSTRACT

A management server includes a management unit configured to manage, for each of one or more projectors, first management information for associating device identification information for identifying the projector and start propriety information indicating propriety of a start of the projector, an acquisition unit configured to acquire, from a first projector, a first inquiry request including the device identification information for identifying the first projector, the first inquiry request inquiring propriety of a start of the first projector, an extraction unit configured to extract, referring to the first management information, start propriety information corresponding to the device identification information included in the first inquiry request, and an output unit configured to output the start propriety information indicating the propriety of the start of the first projector extracted by the extraction unit.

The present application is based on, and claims priority from JP Application Serial Number 2024-039981, filed Mar. 14, 2024, the disclosure of which is hereby incorporated by reference herein in its entirety.

### BACKGROUND

### 1. Technical Field

The present disclosure relates to a management server and a management system.

### 2. Related Art

A management system that determines propriety of a start of a projector has been used. For example, in a control method for a projector according to JP-A-2009-109940, when the projector determines that the projector is not installed at a predetermined position, the projector transmits predetermined identification information of the projector to a management server. When the projector has successfully transmitted the identification information to the management server, the projector causes a projector function to operate. On the other hand, when the projector has not successfully transmitted the identification information to the management server, the projector stops the projector function.

JP-A-2009-109940 is an example of the related art.

In the control method according to JP-A-2009-109940, the projector side determines propriety of a start of the projector. However, when the management server side, not the projector side, needs to determine the propriety of the start of the projector, the control method according to JP-A-2009-109940 cannot be used.

### SUMMARY

A management server according to an aspect of the present disclosure includes: a management unit configured to manage, for each of one or more projectors, first management information that associates device identification information for identifying the projector and start propriety information indicating propriety of a start of the projector; an acquisition unit configured to acquire, from a first projector, a first inquiry request including the device identification information for identifying the first projector, the first inquiry request inquiring propriety of a start of the first projector; an extraction unit configured to extract, referring to the first management information, start propriety information corresponding to the device identification information included in the first inquiry request; and an output unit configured to output the start propriety information indicating the propriety of the start of the first projector extracted by the extraction unit.

A management system according to an aspect of the present disclosure is a management system including: the management server explained above and the first projector, in which the first projector includes: a generation unit configured to generate the first inquiry request based on operation of a user of the first projector; a communication control unit configured to transmit the first inquiry request to the management server and receive a first inquiry response including the start propriety information from the management server; and a start processing unit configured to execute start processing concerning a start of the first projector based on the first inquiry response received by the communication control unit.

### BRIEF DESCRIPTION OF THE DRAWINGS

FIG. 1 is a diagram illustrating an overall configuration of a management system.

FIG. 2 is a block diagram illustrating a configuration example of a management server.

FIG. 3 is a diagram illustrating a configuration example of a management information database.

FIG. 4 is a diagram illustrating a configuration example of a history information database.

FIG. 5 is a block diagram illustrating a configuration of a projector.

FIG. 6 is a sequence diagram illustrating an operation of the management system.

FIG. 7 is a flowchart illustrating sub-steps constituting step S1.

FIG. 8 is a block diagram illustrating a configuration example of a management server.

FIG. 9 is a diagram illustrating a configuration example of an expiration date information database.

FIG. 10 is a flowchart illustrating sub-steps constituting step S1.

FIG. 11 is a diagram illustrating an overall configuration of a management system.

FIG. 12 is a block diagram illustrating a configuration example of an information management device.

FIG. 13 is a sequence diagram illustrating an operation of the management system.

FIG. 14 is a block diagram illustrating a configuration example of a management server.

FIG. 15 is a sequence diagram illustrating an operation of a management system.

FIG. 16 is a flowchart illustrating sub-steps constituting step S42.

FIG. 17 is a block diagram illustrating a configuration of a projector.

FIG. 18 is a flowchart illustrating an operation of the projector.

FIG. 19 is a block diagram illustrating a configuration example of a management server.

FIG. 20 is a diagram illustrating a configuration example of a time information database.

FIG. 21 is a block diagram illustrating a configuration example of a projector.

FIG. 22 is a block diagram illustrating a configuration example of an information management device.

FIG. 23 is a diagram illustrating a configuration example of a history information database.

FIG. 24 is a sequence diagram illustrating an operation of a management system.

FIG. 25 is a sequence diagram illustrating an operation of the management system.

FIG. 26 is a sequence diagram illustrating an operation of the management system.

### DESCRIPTION OF EMBODIMENTS

### 1: First Embodiment

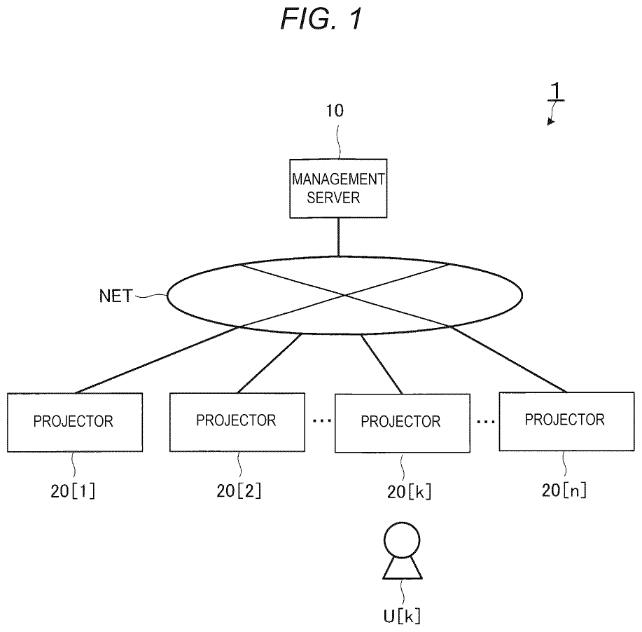

A management system 1 according to a first embodiment is explained below with reference to FIGS. 1 to 7. In the drawings, dimensions and scales of units are differentiated from actual ones as appropriate. Embodiments explained below are suitable specific examples. Therefore various technically preferable limitations are added to the embodiments. However, the scope of the present disclosure is not limited by these embodiments unless it is particularly described in the following explanation that the present disclosure is limited.

### 1-1: Overall Configuration

FIG. 1 is a diagram illustrating an overall configuration of a management system 1 according to the present embodiment. The management system 1 includes a management server 10 and n projectors 20[1] to 20[n]. Here, n is an integer equal to or larger than 1. The management server 10 and the n projectors 20[1] to 20[n] are communicably connected to each other via a communication network NET. In FIG. 1, users U[1] to U[n] use the projectors 20[1] to 20[n]. The users U[1] to U[n] and the projectors 20[1] to 20[n] correspond to each other on a one-to-one basis. A user U[k] uses a projector 20[k]. Here, k is an integer equal to or larger than 1 and equal to or smaller than n. In the following explanation, according to necessity, the user U[k] is sometimes used as a representative example of the users U[1] to U[n] and the projector 20[k] is sometimes used as a representative example of the projectors 20[1] to 20[n]. In the following explanation, according to necessity, an expression “user U” is sometimes used as a general term of the users U[1] to U[n] and an expression “projector 20” is sometimes used as a general term of the projectors 20[1] to 20[n].

The management server 10 is a server that manages the n projectors 20[1] to 20[n]. In the present embodiment, the management server 10 mainly manages propriety of a start of each of the projectors 20[1] to 20[n]. As an example, the management server 10 is operated by a management corporation that manages the projectors 20[1] to 20[n].

Each of the n projectors 20[1] to 20[n] is a device that projects a still image or a moving image on a plane such as a screen or a wall.

### 1-2: Configuration of the Management Server

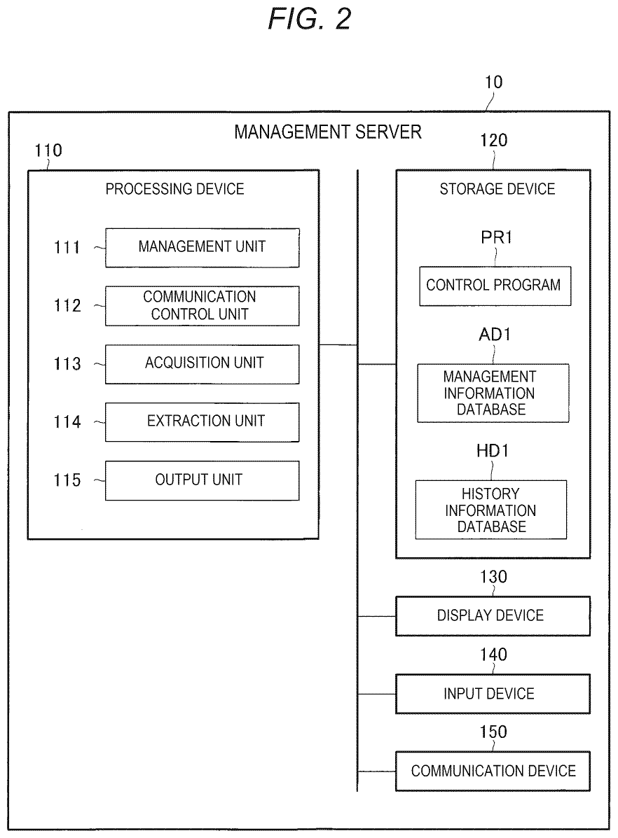

FIG. 2 is a block diagram illustrating a configuration example of the management server 10. The management server 10 is a PC as a typical example but is not limited to the PC and may be, for example, a tablet terminal. The management server 10 includes a processing device 110, a storage device 120, a display device 130, an input device 140, and a communication device 150. The elements of the management server 10 are connected to one another by a single bus or a plurality of buses for communicating information.

The processing device 110 is a processor that controls the entire management server 10 and includes, for example, a single chip or a plurality of chips. The processing device 110 includes, for example, a central processing unit (CPU) including an interface with a peripheral device, an arithmetic device, and a register. A part or all of the functions of the processing device 110 may be implemented by hardware such as a digital signal processor (DSP), an application specific integrated circuit (ASIC), a programmable logic device (PLD), or a field programmable gate array (FPGA). The processing device 110 executes various kinds of processing in parallel or sequentially.

The storage device 120 is a recording medium that can be read and written by the processing device 110. The storage device 120 stores a plurality of programs including a control program PR1 to be executed by the processing device 110, a management information database AD1, and a history information database HD1. The storage device 120 may include at least one of, for example, a read only memory (ROM), an erasable programmable ROM (EPROM), an electrical erasable programmable ROM (EEPROM), a random access memory (RAM), and the like. The storage device 120 may be called register, cache, main memory, main storage device, or the like.

The management information database AD1 is a database in which management information AI is stored. In the present embodiment, the management information AI is information for managing the projectors 20[1] to 20[n]. The management information AI in the present embodiment is an example of “first management information”.

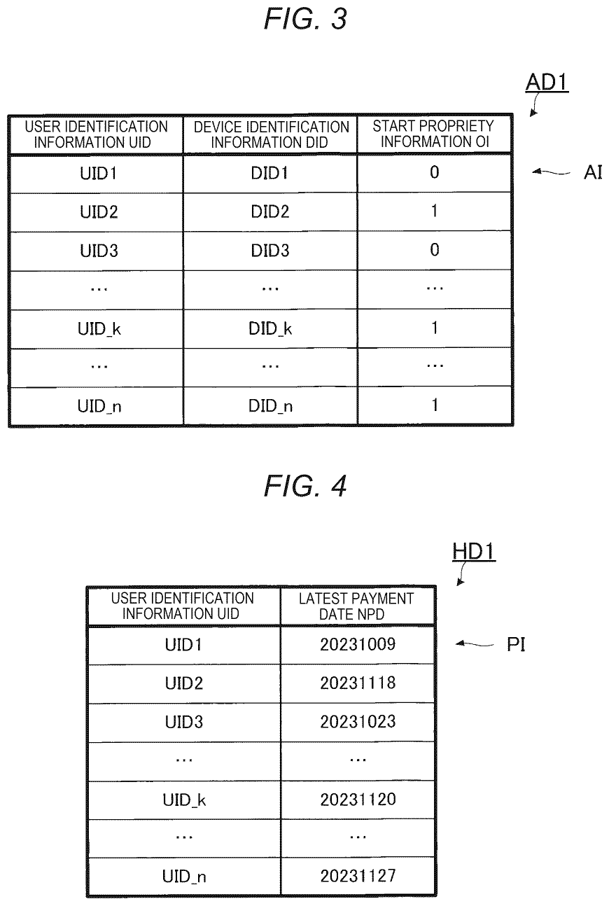

FIG. 3 is a diagram illustrating a configuration example of the management information database AD1. In the management information database AD1, user identification information UID for identifying each of the users U[1] to U[n], device identification information DID for identifying each of the projectors 20[1] to 20[n], and start propriety information OI indicating propriety of a start of the projectors 20[1] to 20[n] are stored in association with one another as the management information AI.

In the management information database AD1 illustrated in FIG. 3, a user whose user identification information UID is “UID1” corresponds to the user U[1] in FIG. 1. Similarly, a user whose user identification information UID is “UID_k” corresponds to the user U[k] in FIG. 1. A user whose user identification information UID is “UID_n” corresponds to the user U[n] in FIG. 1.

In the management information database AD1 illustrated in FIG. 3, a projector whose device identification information DID is “DID1” corresponds to the projector 20[1] in FIG. 1. Similarly, a projector whose device identification information DID is “DID_k” corresponds to the projector 20[k] in FIG. 1. A projector whose device identification information DID is “DID n” corresponds to the projector 20[n] in FIG. 1.

In the management information database AD1 illustrated in FIG. 3, concerning the start propriety information OI, “1” indicates that the projectors 20[1] to 20[n] can be started and “0” indicates that the projectors 20[1] to 20[n] cannot be started.

In the example illustrated in FIG. 3, as an example, the management information AI indicating that the user U[k] whose user identification information UID is “UID_k” uses the projector 20[k] whose device identification information DID is “DID_k” and the projector 20[k] can be started at the present point in time is stored in the management information database AD1.

In the example illustrated in FIG. 3, for simplification of description, for example, the device identification information DID of the projector 20[k] whose user identification information UID corresponds to “UID_k” is “DID_k”. However, this is only an example. The device identification information DID may be an ID for identifying each projector 20 or may be an identification code. The identification code may be a serial number of each projector 20 or may be a MAC address of each projector 20. The device identification information DID may be, for example, a combination of the user identification information UID and a name set in the projector 20 by the user U.

In FIG. 2, the history information database HD1 is a database in which payment history information PI is stored. In the present embodiment, the payment history information PI is information indicating a payment history of a use fee of the projector 20 by each user U.

FIG. 4 is a diagram illustrating a configuration example of the history information database HD1. In the history information database HD1, the user identification information UID and a latest payment date NPD are stored in association with each other as the payment history information PI.

In the example illustrated in FIG. 4, as an example, the latest payment date NPD of the use fee of the projector 20[k] by the user U[k] whose user identification information UID is “UID_k” is Nov. 20, 2023.

Here, it is assumed that the present date is Dec. 1, 2023. It is also assumed that the nearest payment due date in the past is Nov. 30, 2023 and the preceding payment due date is Oct. 31, 2023.

In the history information database HD1 illustrated in FIG. 4, as an example, the latest payment date NPD of the user U[1] whose user identification information UID is “UID1” is “20231009”, that is, Oct. 9, 2023. Therefore, the payment history information PI of the user U[1] has not been updated between the nearest payment due date in the past and the preceding payment due date. For this reason, in the example illustrated in FIG. 3, the start propriety information OI of the projector 20[1] whose device identification information DID is “DID1” used by the user U[1] whose user identification information UID is “UID1” is “0”. That is, the projector 20[1] cannot be started.

In the history information database HD1 illustrated in FIG. 4, as another example, the latest payment date NPD of the user U[2] whose user identification information UID is “UID2” is “20231118”, that is, Nov. 18, 2024. Therefore, the payment history information PI of the user U[2] has been updated between the nearest payment due date in the past and the preceding payment due date. For this reason, in the example illustrated in FIG. 3, the start propriety information OI of the projector 20[1] whose device identification information DID is “DID2” used by the user U[2] whose user identification information UID is “UID2” is “1”. That is, the projector 20[2] can be started.

In FIG. 2, the display device 130 is a device that displays images and character information. The display device 130 displays various images under control by the processing device 110. For example, various display panels such as a liquid crystal display panel and an organic EL (Electro Luminescence) display panel are suitably used as the display device 130.

The input device 140 is equipment that receives operation from an administrator of the management server 10. For example, the input device 140 includes a pointing device such as a keyboard, a touch pad, a touch panel, or a mouse. When the input device 140 includes the touch panel, the input device 140 may also serve as the display device 130.

The communication device 150 is hardware serving as a transmission and reception device for communicating with other devices. The communication device 150 is also called, for example, network device, network controller, network card, or communication module.

The processing device 110 functions as a management unit 111, a communication control unit 112, an acquisition unit 113, an extraction unit 114, and an output unit 115 by reading the control program PR1 from the storage device 120 and executing the control program PR1. The control program PR1 may be transmitted from, via the communication network NET, another device that manages the management server 10.

The management unit 111 manages the management information AI stored in the management information database AD1. In the present embodiment, the management unit 111 manages the management information AI based on the payment history information PI stored in the history information database HD1.

Specifically, as explained above, in the history information database HD1, when the payment history information PI corresponding to each user U identified by the user identification information UID has been updated between the nearest payment due date in the past and the preceding payment due date, the management unit 111 sets the start propriety information OI corresponding to the user U to “1”. On the other hand, when the payment history information PI corresponding to each user U identified by the user identification information UID has not been updated between the nearest payment due date in the past and the preceding payment due date, the management unit 111 sets the start propriety information OI corresponding to the user U to “0”.

The communication control unit 112 causes the communication device 150 to receive an inquiry request from each of the projectors 20[1] to 20[n]. The inquiry request includes the device identification information DID for identifying each of the projectors 20[1] to 20[n] and inquires propriety of a start of each of the projectors 20 [1] to 20[n]. In the following explanation, it is assumed that the communication control unit 112 causes the communication device 150 to receive, from the projector 20[k], an inquiry request including “DID_k” as the device identification information DID for identifying the projector 20[k], the inquiry request inquiring of a start of the projector 20[k]. The inquiry request is an example of a “first inquiry request”. The projector 20[k] is an example of a “first projector”.

The acquisition unit 113 acquires the inquiry request received by the communication device 150.

The acquisition unit 113 acquires, from a terminal device other than the management server 10, information for notifying that the use fee of the projector 20 has been paid. As an example, the acquisition unit 113 acquires, from a terminal device used by the user U[k], information for notifying that the use fee of the projector 20[k] has been paid. In this case, the management unit 111 updates, based on the information, the payment history information PI corresponding to the projector 20[k] stored in the history information database HD1.

The extraction unit 114 extracts the start propriety information OI corresponding to the device identification information DID by referring to the management information AI stored in the management information database AD1 using the device identification information DID included in the inquiry request acquired by the acquisition unit 113. In the example explained above, the extraction unit 114 extracts “1” as the start propriety information OI from the management information AI corresponding to “DID_k” that is the device identification information DID included in the inquiry request.

The output unit 115 outputs the start propriety information OI extracted by the extraction unit 114. In the example explained above, the output unit 115 outputs “1” as the start propriety information OI. In the present embodiment, as an example, the output unit 115 outputs the start propriety information OI to the communication control unit 112.

The communication control unit 112 causes the communication device 150 to transmit, to any one of the projectors 20[1] to 20[n], the start propriety information OI output from the output unit 115. In the example explained above, the communication control unit 112 causes the communication device 150 to transmit an inquiry response including “1” as the start propriety information OI to the projector 20[k]. The inquiry response is an example of a “first inquiry response”.

### 1-3: Configuration of the Projector

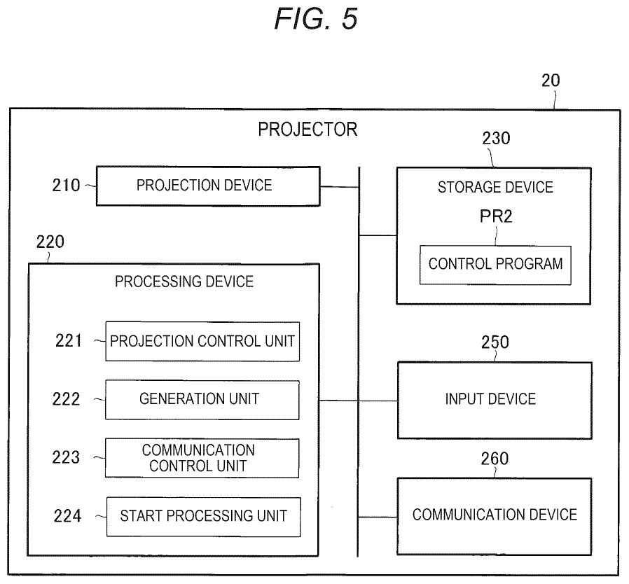

FIG. 5 is a block diagram illustrating a configuration of the projector 20. The projector 20 includes a projection device 210, a processing device 220, a storage device 230, an input device 250, and a communication device 260. The elements of the projector 20 are connected to one another by a single bus or a plurality of buses for communicating information. The elements of the projector 20 include a single or a plurality of devices. A part of the elements of the projector 20 may be omitted.

The projection device 210 is a device that projects a still image or a moving image onto a screen, a wall, or the like. The projection device 210 projects various still images and various moving images under control of the processing device 220. The projection device 210 includes, for example, a light source, a liquid crystal panel, and a projection lens. The projection device 210 modulates light from a light source using a liquid crystal panel and projects the modulated light onto the screen, the wall, or the like via the projection lens. An aspect in which the projection device 210 includes the liquid crystal panel is only an example and an aspect according to the present embodiment is not limited the aspect. For example, the present embodiment is also applicable to, instead of the liquid crystal panel, a digital light processing (DLP: registered trademark) panel including a digital mirror device (DMD).

The processing device 220 is a processor that controls the entire projector 20. The processing device 220 includes, for example, a single chip or a plurality of chips. The processing device 220 includes, for example, a central processing unit (CPU) including an interface with a peripheral device, an arithmetic device, and a register. A part or all of the functions of the processing device 220 may be implemented by hardware such as a DSP, an ASIC, a PLD, or an FPGA. The processing device 220 executes various kinds of processing in parallel or sequentially.

The storage device 230 is a recording medium readable by the processing device 220 and stores a plurality of programs including a control program PR2 to be executed by the processing device 220. The storage device 230 may include at least one of, for example, a ROM, an EPROM, an EEPROM, and a RAM. The storage device 230 may be called register, cache, main memory, main storage device, or the like.

The input device 250 is equipment that receives operation from the user U of the projector 20. For example, the input device 250 includes devices such as an input button, a touch pad, and a touch panel. The input device 250 is also used to turn on and turn off the projector 20.

The communication device 260 is hardware serving as a transmission and reception device for communicating with other devices. In the present embodiment, the communication device 260 is a communication device for connecting the projector 20 to other devices by wire or radio. The communication device 260 is also called, for example, network device, network controller, network card, or communication module.

The processing device 220 functions as a projection control unit 221, a generation unit 222, a communication control unit 223, and a start processing unit 224 by reading the control program PR2 from the storage device 230 and executing the control program PR2. The control program PR2 may be transmitted from, via the communication network NET, another device such as the management server 10 that manages the projector 20.

The projection control unit 221 causes the projection device 210 to project a still image or a moving image onto a wall, a screen, or the like.

The generation unit 222 generates the inquiry request explained above based on operation of the user U performed by using the input device 250.

The communication control unit 223 causes the communication device 260 to transmit the inquiry request generated by the generation unit 222 to the management server 10. The communication control unit 223 causes the communication device 260 to receive, from the management server 10, an inquiry response transmitted from the management server 10.

The start processing unit 224 executes start processing concerning a start of the projector 20 based on the inquiry response received from the management server 10 using the communication device 260. In the example explained above, when the inquiry response includes “1” as the start propriety information OI, the start processing unit 224 executes the start processing of starting the projector 20. On the other hand, when the inquiry response includes “0” as the start propriety information OI, the start processing unit 224 does not execute the start processing of starting the projector 20. Alternatively, when the inquiry response includes “0” as the start propriety information OI, the start processing unit 224 suspends the start processing of starting the projector 20.

When the communication control unit 223 has not successfully caused the communication device 260 to transmit the inquiry request generated by the generation unit 222 to the management server 10, the start processing unit 224 may not start the projector 20. Similarly, when the communication control unit 223 has not successfully caused the communication device 260 to receive, from the management server 10, the inquiry response transmitted from the management server 10, the start processing unit 224 may not start the projector 20.

In these cases, the start processing unit 224 may control a light source provided in the projection device 210 not to be turned on. Alternatively, the start processing unit 224 may disable the projection control unit 221 to process a video signal and project a still image or a moving image, although the light source is turned on. Alternatively, the start processing unit 224 may project, on a screen, using the projection device 210, a message for notifying that the projector 20 cannot be used. Alternatively, the start processing unit 224 may project, on the screen, using the projection device 210, a message for notifying that a payment of a use fee by the user U is delayed.

### 1-4: Operation of the Management System

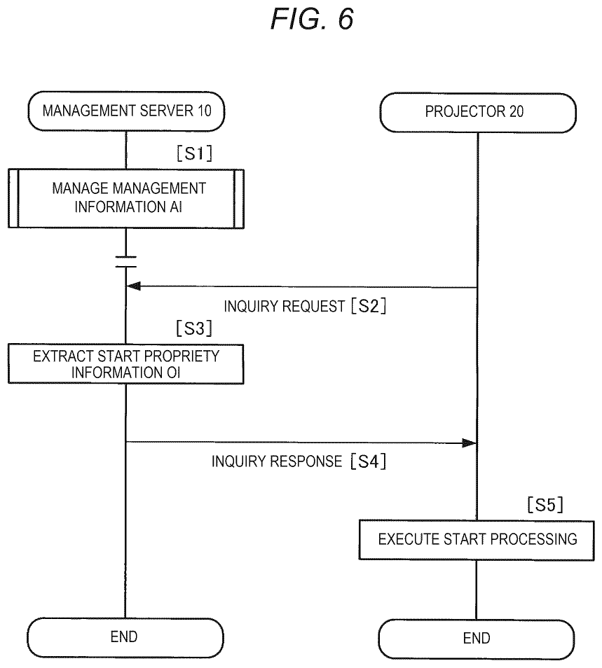

FIG. 6 is a sequence diagram illustrating an operation of the management system 1. More specifically, FIG. 6 is a sequence diagram illustrating an operation in the case in which the projector 20 executes the start processing in the management system 1.

In step S1, the processing device 110 provided in the management server 10 operates as the management unit 111. The processing device 110 manages the management information AI stored in the management information database AD1.

In step S2, the processing device 220 provided in the projector 20 functions as the generation unit 222. The processing device 220 generates, based on operation of the user U, an inquiry request for inquiring propriety of a start of the projector 20. The processing device 220 functions as the communication control unit 223. The processing device 220 causes the communication device 260 to transmit the generated inquiry request to the management server 10.

The processing device 110 provided in the management server 10 functions as the acquisition unit 113. The processing device 110 causes the communication device 150 to receive, from the projector 20, an inquiry request including the device identification information DID for identifying the projector 20, the inquiry request inquiring propriety of a start of the projector 20, and acquires the inquiry request.

In step S3, the processing device 110 provided in the management server 10 functions as the extraction unit 114. The processing device 110 refers to the management information AI stored in the management information database AD1 and extracts the start propriety information OI corresponding to the device identification information DID included in the inquiry request acquired in step S2.

In step S4, the processing device 110 provided in the management server 10 functions as the output unit 115. The processing device 110 outputs the start propriety information OI extracted in step S3. Specifically, the processing device 110 causes the communication device 150 to transmit an inquiry response including the start propriety information OI to the projector 20.

The processing device 220 provided in the projector 20 functions as the communication control unit 223. The processing device 220 causes the communication device 260 to receive the inquiry response including the start propriety information OI from the management server 10.

In step S5, the processing device 220 provided in the projector 20 functions as the start processing unit 224. The processing device 220 executes start processing concerning a start of the projector 20 based on the inquiry response received in step S4.

More specifically, when the start propriety information OI included in the inquiry response received in step S4 is “appropriate”, the processing device 220 executes the start processing of starting the projector 20. On the other hand, when the start propriety information OI included in the inquiry response received in step S4 is “inappropriate”, the processing device 220 does not execute the start processing of starting the projector 20. Alternatively, the processing device 220 suspends the start processing of starting the projector 20. Alternatively, the processing device 220 turns off the projector 20.

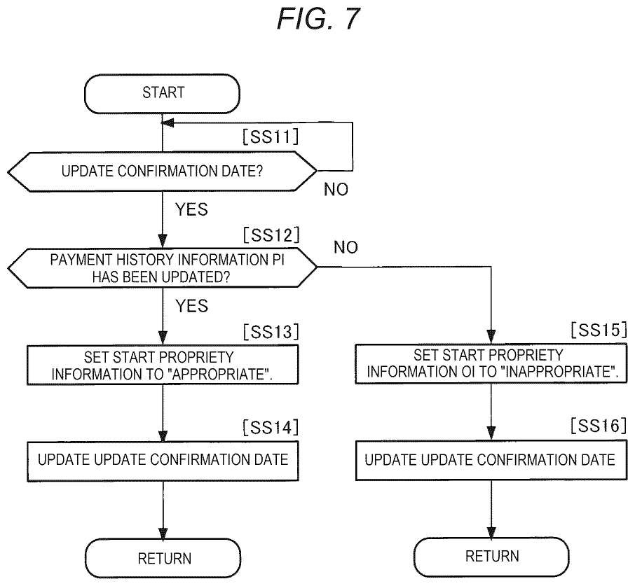

FIG. 7 is a flowchart illustrating sub-steps constituting step S1 in the present embodiment. Step S1 includes sub-steps SS11 to SS16.

In Sub-step SS11, the processing device 110 provided in the management server 10 functions as the management unit 111. The processing device 110 determines whether the present point in time is an update confirmation date for confirming update of the payment history information PI. When the present point in time is the update confirmation date (“YES” in sub-step SS11), the processing device 310E executes processing in step S12. When the present point in time is not the update confirmation date (“NO” in sub-step SS11), the processing device 310E executes processing in sub-step SS11.

Here, the update confirmation date is, for example, the end of every month. The update confirmation date may be the next day of a payment due date of the use fee of the projector 20. The processing in sub-step SS11 is executed once a day by batch processing as an example.

In sub-step SS12, the processing device 110 provided in the management server 10 functions as the management unit 111. The processing device 110 determines whether the payment history information PI has been updated between the nearest payment due date in the past and the preceding payment due date. When the payment history information PI has been updated, the processing device 110 executes processing of sub-step SS13. When the payment history information PI has not been updated, the processing device 110 executes processing in sub-step SS15.

In sub-step SS13, the processing device 110 provided in the management server 10 functions as the management unit 111. The processing device 110 sets the start propriety information OI to “appropriate”.

In sub-step SS14, the processing device 110 provided in the management server 10 functions as the management unit 111. The processing device 110 updates the update confirmation date to the next update confirmation date.

In sub-step SS15, the processing device 110 provided in the management server 10 functions as the management unit 111. The processing device 110 sets the start propriety information OI to “inappropriate”.

In sub-step SS16, the processing device 110 provided in the management server 10 functions as the management unit 111. The processing device 110 updates the update confirmation date to the next update confirmation date.

### 2: Second Embodiment

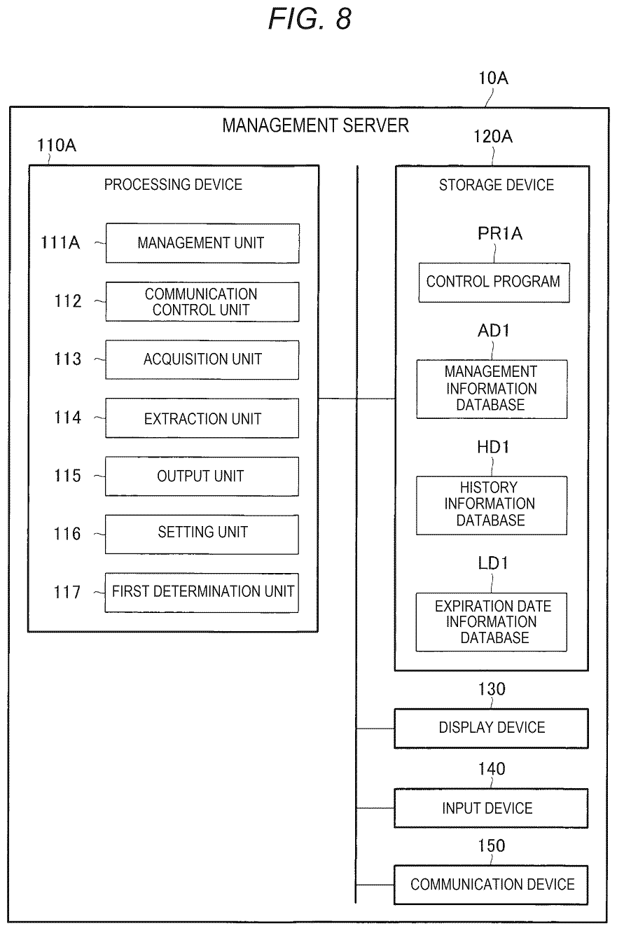

A management system 1A according to a second embodiment is explained below with reference to FIGS. 8 to 10. For simplification of explanation, in the following explanation, differences of the management system 1A according to the present embodiment from the management system 1 according to the first embodiment are mainly explained. Among the constituent elements provided in the management system 1A according to the present embodiment, the same constituent elements as the elements of the management system 1 according to the first embodiment are denoted by the same reference numerals and signs and explanation of functions of the elements is sometimes omitted.

The management system 1 according to the first embodiment manages, according to whether the payment history information PI has been updated between the nearest payment due date in the past and the preceding payment due date, the start propriety information OI indicating propriety of a start of the projector 20. On the other hand, the management system 1A according to the present embodiment sets a first expiration date of use and a second expiration date of use according to the payment history information PI. The second expiration date of use is an expiration date of use later than the first expiration date of use. A period between the first expiration date of use and the second expiration date of use is equivalent to a grace period in the case in which the user U does not pay the use fee of the projector 20 by the first expiration date of use.

### 2-1: Overall Configuration

Unlike the management system 1 according to the first embodiment, the management system 1A according to the present embodiment includes a management server 10A instead of the management server 10. Otherwise, an overall configuration of the management system 1A is the same as the overall configuration of the management system 1 illustrated in FIG. 1. Therefore, illustration of the overall configuration is omitted.

### 2-2: Configuration of the Management Server

FIG. 8 is a block diagram illustrating a configuration example of the management server 10A. Unlike the management server 10, the management server 10A includes a processing device 110A instead of the processing device 110 and includes a storage device 120A instead of the storage device 120.

Unlike the storage device 120, the storage device 120A stores a control program PR1A instead of the control program PR1. The storage device 120A stores an expiration date information database LD1 in addition to the management information database AD1 and the history information database HD1.

The expiration date information database LD1 is a database in which expiration date information LI is stored. In the present embodiment, the expiration date information LI is information indicating an expiration date of use until when each user U can use the projector 20.

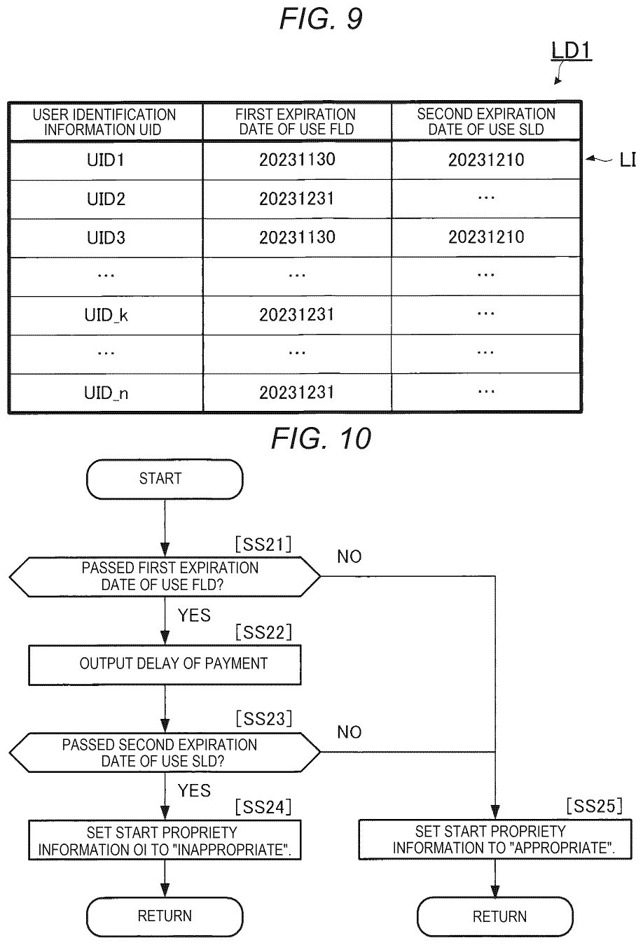

FIG. 9 is a diagram illustrating a configuration example of the expiration date information database LD1. The expiration date information LI is information that associates the user identification information UID capable of identifying each of the users U[1] to U[n], a first expiration date of use FLD, and a second expiration date of use SLD.

The first expiration date of use FLD indicates the expiration date until when the user U can use the projector 20 according to payment of a use fee of the user U. When the payment history information PI stored in the history information database HD1 is updated, the first expiration date of use FLD is updated. As an example, when the nearest payment due date is Nov. 30, 2023 and the preceding payment due date is Oct. 31, 2023, if the user U pays a use fee of the projector 20 in a period from Oct. 31, 2023 to Nov. 30, 2023, the first expiration date of use FLD is set to the last day of December after Nov. 30, 2023 that is the nearest payment due date. On the other hand, when the user U has not paid the use fee of the projector 20 in the period from Oct. 31, 2023 to Nov. 30, 2023, the first expiration date of use FLD is not updated. The first expiration date of use FLD is an example of a “first expiration date of use”.

The second expiration date of use SLD is an expiration date until when the user can use the projector 20 even if the user U has not paid the use fee of the projector 20 in a period from the last payment due date to the nearest payment due date. The second expiration date of use SLD is a grace period for the user U to pay the use fee of the projector 20 that should be paid in the period from the last payment date to the nearest payment date. The second expiration date of use SLD is set by a setting unit 116 explained below when the user U has not paid the use fee of the projector 20 even if the present point in time has passed the first expiration date of use FLD. The second expiration date of use SLD is an example of a “second expiration date”. As an example, when the user U has not paid the use fee of the projector 20 even if the present point in time has passed Nov. 30, 2023 that is the first expiration date of use FLD, the setting unit 116 sets Dec. 10, 2023 as the second expiration date of use SLD.

In FIG. 8, the processing device 110A functions as a setting unit 116 and a first determination unit 117 in addition to a management unit 111A, the communication control unit 112, the acquisition unit 113, the extraction unit 114, and the output unit 115 by reading the control program PR1A from the storage device 120A and executing the control program PR1A.

The setting unit 116 sets the first expiration date of use FLD of each of the projectors 20[1] to 20[n]. More specifically, the setting unit 116 updates the first expiration date of use FLD according to update of the payment history information PI stored in the history information database HD1.

The first determination unit 117 determines whether the present point in time has passed the first expiration date of use FLD. When the first determination unit 117 determines that the present point in time has passed the first expiration date of use FLD, the setting unit 116 sets the second expiration date of use SLD.

In the history information database HD1, when the payment history information PI corresponding to each user U identified by the user identification information UID has been updated by the first expiration date of use FLD, the management unit 111A sets the start propriety information OI corresponding to the user U to “1”. In the history information database HD1, when the payment history information PI corresponding to each user U identified by the user identification information UID has been updated by the second expiration date of use SLD, the management unit 111A sets the start propriety information OI corresponding to the user U to “1”. On the other hand, in the history information database HD1, when the payment history information PI corresponding to each user U identified by the user identification information UID has not been updated by the second expiration date of use SLD, the management unit 111A sets the start propriety information OI corresponding to the user U to “0”.

### 2-3: Operation of the Management System

Since an operation of the management system 1A is the same as the operation of the management system 1 illustrated in FIG. 6, illustration of the operation is omitted. However, the operation of the management system 1A is different from the operation of the management system 1 in contents of the sub-steps constituting the processing in step S1. FIG. 10 is a flowchart illustrating sub-steps constituting step S1 in the present embodiment. Step S1 includes sub-steps SS21 to SS25.

In sub-step SS21, the processing device 110A provided in the management server 10 functions as the management unit 111A. The processing device 110 determines whether the present point in time has passed the first expiration date of use FLD. When the present point in time has passed the first expiration date of use FLD (“YES” in sub-step SS21), the processing device 110 executes processing in sub-step SS22. When the present point in time has not passed the first expiration date of use FLD (“NO” in sub-step SS21), the processing device 110 executes processing in sub-step SS25.

Here, the first expiration date of use FLD is the end of each month as an example. The first expiration date of use FLD may be the same as the payment due date of the use fee of the projector 20.

In sub-step SS22, the processing device 110A provided in the management server 10 functions as the output unit 115. The processing device 110A outputs, to a terminal device used by the user U or the projector 20 used by the user U, a message for notifying that the payment of the use fee by the user U is delayed.

In sub-step SS23, the processing device 110 provided in the management server 10 functions as the management unit 111A. The processing device 110 determines whether the present point in time has passed the second expiration date of use SLD. When the present point in time has passed the second expiration date of use SLD (“YES” in sub-step SS23), the processing device 110 executes processing in sub-step SS24. When the present point in time has not passed the second expiration date of use SLD (“NO” in sub-step SS23), the processing device 110 executes processing in sub-step SS25.

In sub-step SS24, the processing device 110 provided in the management server 10 functions as the management unit 111A. The processing device 110 sets the start propriety information OI to “inappropriate”.

In sub-step SS25, the processing device 110 provided in the management server 10 functions as the management unit 111A. The processing device 110 sets the start propriety information OI to “appropriate”.

The processing in step S1 including sub-steps SS21 to SS25 is executed once a day by batch processing as an example.

### 3: Third Embodiment

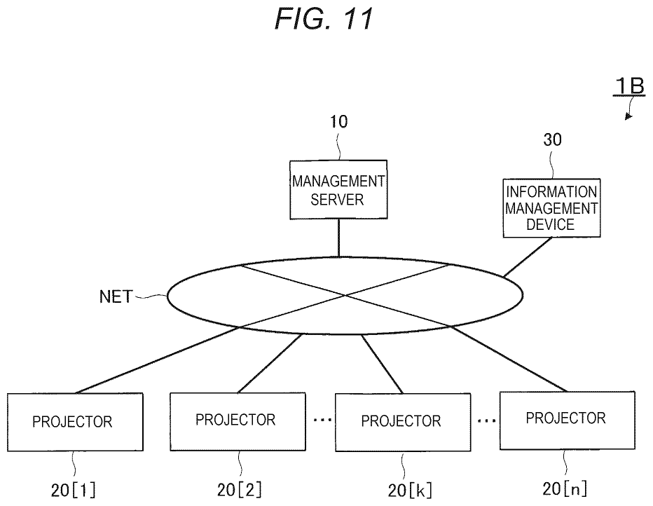

A management system 1B according to a third embodiment is explained below with reference to FIGS. 11 to 13. For simplification of explanation, in the following explanation, differences of the management system 1B according to the present embodiment from the management system 1 according to the first embodiment are mainly explained. Among constituent elements provided in the management system 1B according to the present embodiment, the same constituent elements as the elements of the management system 1 according to the first embodiment are denoted by the same reference numerals and signs and explanation of the functions is sometimes omitted.

The management system 1 according to the first embodiment includes the management server 10 and the projectors 20[1] to 20[n]. The management system 1B according to the present embodiment further includes an information management device 30. The information management device 30 mainly manages the payment history information PI of the users U[1] to U[n]. The information management device 30 transmits the payment history information PI of the users U[1] to U[n] to the management server 10.

### 3-1: Overall Configuration

FIG. 11 is a diagram illustrating an overall configuration of the management system 1B according to the present embodiment. The management system 1B includes the management server 10, the n projectors 20[1] to 20[n], and the information management device 30. The management server 10, the n projectors 20[1] to 20[n], and the information management device 30 are communicably connected to one another via the communication network NET.

As explained above, the information management device 30 manages the payment history information PI of the users U[1] to U[n].

### 3-2: Configuration of the Information Management Device

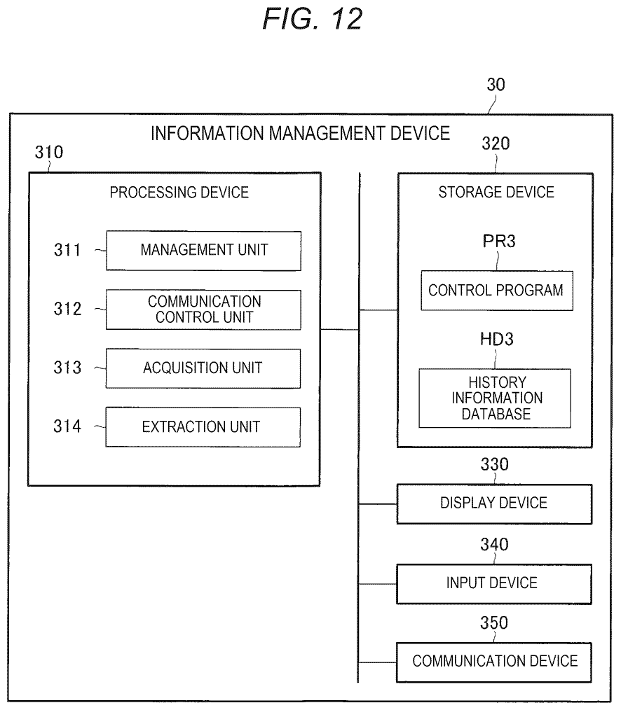

FIG. 12 is a block diagram illustrating a configuration example of the information management device 30. The information management device 30 is a PC as a typical example but is not limited the PC and may be, for example, a tablet terminal or a smartphone. The information management device 30 includes a processing device 310, a storage device 320, a display device 330, an input device 340, and a communication device 350. The elements of the information management device 30 are connected to one another by a single bus or a plurality of buses for communicating information.

The processing device 310 is a processor that controls the entire information management device 30 and includes, for example, a single chip or a plurality of chips. The processing device 310 includes, for example, a central processing unit (CPU) including an interface with a peripheral device, an arithmetic device, and a register. A part or all of the functions of the processing device 310 may be implemented by hardware such as a DSP, an ASIC, a PLD, or an FPGA. The processing device 310 executes various kinds of processing in parallel or sequentially.

The storage device 320 is a recording medium that can be read and written by the processing device 310 and stores a plurality of programs including a control program PR3 to be executed by the processing device 310 and a history information database HD3. The storage device 320 may include at least one of, for example, a ROM, an EPROM, an EEPROM, and a RAM. The storage device 320 may be called register, cache, main memory, main storage device, or the like.

Since the history information database HD3 is the same database as the history information database HD1 according to the first embodiment illustrated in FIG. 4, illustration of the history information database HD3 and explanation of a configuration of the history information database HD3 are omitted.

In FIG. 12, the display device 330 is a device that displays images and character information. The display device 330 displays various images under control by the processing device 310. For example, various display panels such as a liquid crystal display panel and an organic EL display panel are suitably used as the display device 330.

The input device 340 is equipment that receives operation from an administrator of the information management device 30. For example, the input device 340 includes a pointing device such as a keyboard, a touch pad, a touch panel, or a mouse. When the input device 340 includes the touch panel, the input device 340 may also serve as the display device 330.

The communication device 350 is hardware serving as a transmission and reception device for communicating with other devices. The communication device 350 is also called, for example, network device, network controller, network card, or communication module.

The processing device 310 functions as a management unit 311, a communication control unit 312, an acquisition unit 313, and an extraction unit 314 by reading the control program PR3 from the storage device 320 and executing the control program PR3. The control program PR3 may be transmitted from, via the communication network NET, another device that manages the information management device 30.

The management unit 311 manages payment history information PI stored in the history information database HD3. Specifically, when each of the users U[1] to U[n] has paid the use fee of each of the projectors 20[1] to 20[n], the management unit 311 updates a value of the latest payment date NPD included in the payment history information PI to a value indicating a date of the latest payment date.

The communication control unit 312 causes the communication device 350 to receive an inquiry request from the management server 10. The inquiry request includes the user identification information UID for identifying the users U[1] to U[n] of the projectors 20[1] to 20[n]. The inquiry request is a request for inquiring the payment history information PI corresponding to each of the users U[1] to U[n]. The inquiry request is an example of a “second inquiry request”. In the following explanation, as an example, it is assumed that the inquiry request includes the user identification information UID for identifying the user U[k] of the projector 20[k].

The acquisition unit 313 acquires the inquiry request that the communication control unit 312 has caused the communication device 350 to receive.

The extraction unit 314 extracts the payment history information PI corresponding to the user U corresponding to the user identification information UID by referring to the history information database HD3 using the user identification information UID included in the inquiry request acquired by the acquisition unit 313. In the example explained above, the extraction unit 314 extracts payment history information PI corresponding to the user U[k] using “Uk” that is the user identification information UID included in the inquiry request. In the payment history information PI, the user identification information UID is “Uk” and the latest payment date NPD is “20231120”.

The communication control unit 312 causes the communication device 350 to transmit, to the management server 10, an inquiry response including the payment history information PI extracted by the extraction unit 314. The inquiry response is an example of a “second inquiry response”.

### 3-3: Operation of the Management System

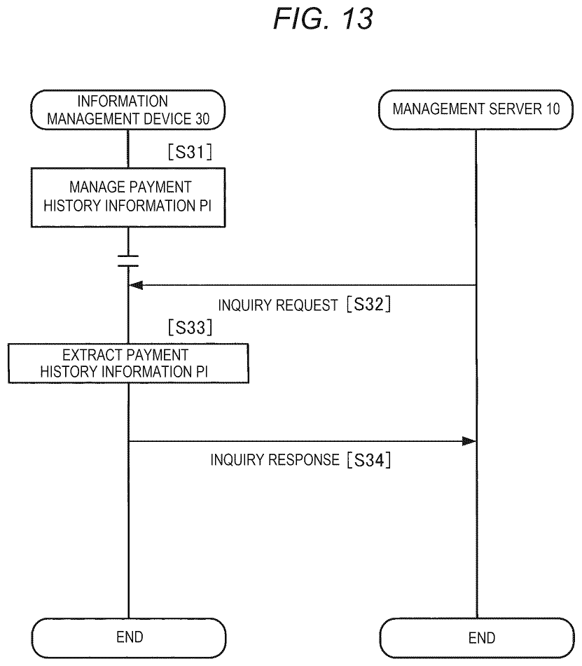

FIG. 13 is a sequence diagram illustrating an operation of the management system 1B. More specifically, FIG. 13 is a sequence diagram illustrating an operation in the case in which the information management device 30 transmits the payment history information PI to the management server 10 in the management system 1B.

In step S31, the processing device 310 provided in the information management device 30 operates as the management unit 311. The processing device 310 manages the payment history information PI stored in the history information database HD3.

In step S32, the processing device 110 provided in the management server 10 functions as the management unit 111. The processing device 110 generates an inquiry request that is a request for inquiring the payment history information PI corresponding to the user U[k]. The processing device 110 functions as the communication control unit 112. The processing device 110 causes the communication device 150 to transmit the generated inquiry request to the information management device 30.

The processing device 310 provided in the information management device 30 functions as the acquisition unit 313. The processing device 310 causes the communication device 350 to receive, from the management server 10, an inquiry request including user identification information UID for identifying the user U[k], the payment history information PI corresponding to the user U[k], and acquires the inquiry request.

In step S33, the processing device 310 provided in the information management device 30 functions as the extraction unit 314. The processing device 310 extracts the payment history information PI corresponding to the user U[k] corresponding to the user identification information UID by referring to the history information database HD3 using the user identification information UID included in the inquiry request acquired in step S32.

In step S34, the processing device 310 provided in the information management device 30 functions as the communication control unit 312. The processing device 310 causes the communication device 350 to transmit, to the management server 10, an inquiry response including the payment history information PI extracted in step S33.

The processing device 310 provided in the management server 10 functions as the communication control unit 112. The processing device 310 causes the communication device 260 to receive, from the information management device 30, an inquiry response including the payment history information PI.

The management server 10 may store the payment history information PI received from the information management device 30 in the history information database HD1. Alternatively, the management server 10 may not include the history information database HD1 and the management unit 111 may manage, based on the payment history information PI received from the information management device 30, the management information AI stored in the management information database AD1.

Thereafter, as an example, the management server 10 executes a series of operations illustrated in FIG. 6.

### 4: Fourth Embodiment

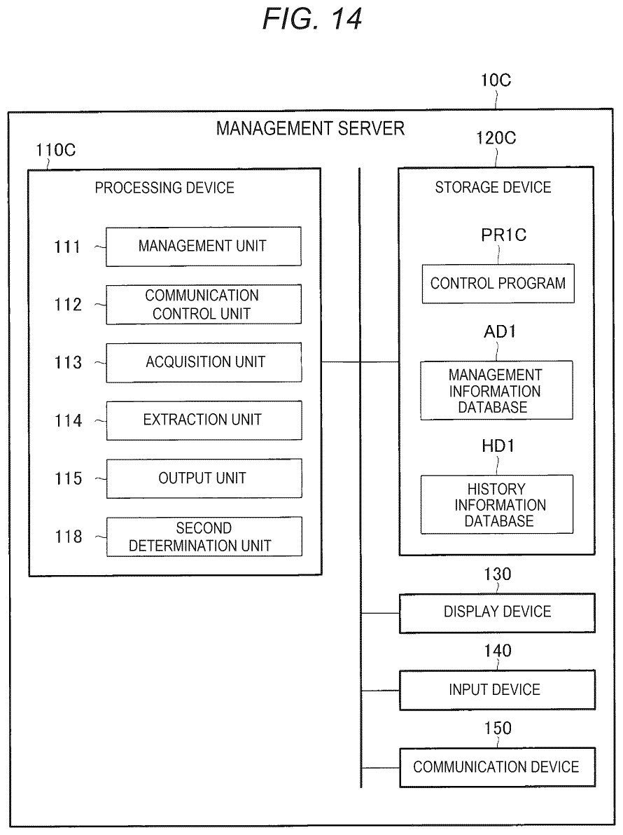

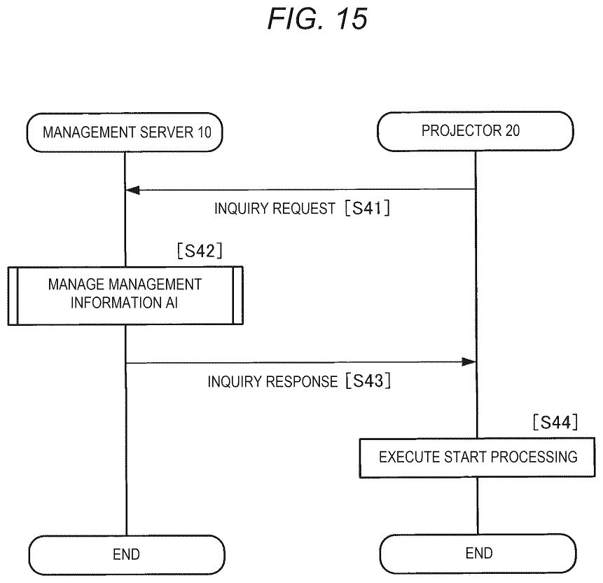

A management system 1C according to a fourth embodiment is explained below with reference to FIGS. 14 and 15. For simplification of explanation, in the following explanation, differences of the management system 1C according to the present embodiment from the management system 1 according to the first embodiment are mainly explained. Among the constituent elements provided in the management system 1C according to the present embodiment, the same constituent elements as the elements of the management system 1 according to the first embodiment are denoted by the same reference numerals and signs and explanation of functions of the element is sometimes omitted.

The management system 1 according to the first embodiment manages the start propriety information OI according to whether the payment history information PI has been updated between the nearest payment due date in the past and the preceding payment due date. On the other hand, the management system 1C according to the present embodiment manages the start propriety information OI according to whether the present point in time is within a maintenance period.

### 4-1: Overall Configuration

Unlike the management system 1 according to the first embodiment, a management system 1C according to the present embodiment includes a management server 10C instead of the management server 10. Otherwise, an overall configuration of the management system 1C is the same as the overall configuration of the management system 1 illustrated in FIG. 1. Therefore, illustration of the overall configuration is omitted.

### 4-2: Configuration of the Management Server

FIG. 14 is a block diagram illustrating a configuration example of the management server 10C. Unlike the management server 10, the management server 10C includes a processing device 110C instead of the processing device 110 and includes a storage device 120C instead of the storage device 120.

Unlike the storage device 120, the storage device 120C stores a control program PR1C instead of the control program PR1.

The processing device 110C functions as a second determination unit 118 in addition to the management unit 111, the communication control unit 112, the acquisition unit 113, the extraction unit 114, and the output unit 115 by reading the control program PR1C from the storage device 120C and executing the control program PR1C.

When the acquisition unit 113 acquires an inquiry request from any one of the projectors 20[1] to 20[n], the second determination unit 118 determines whether the present point in time is within a maintenance period of the management server 10C. When the second determination unit 118 determines that the present point in time is within the maintenance period of the management server 10C, the management unit 111 sets the start propriety information OI included in the management information AI corresponding to the projector 20 at an acquisition source of the inquiry request to “1” in the management information database AD1.

The output unit 115 outputs the start propriety information OI.

### 4-3: Operation of the Management System

FIG. 15 is a sequence diagram illustrating the operation of the management system 1C. More specifically, FIG. 15 is a sequence diagram illustrating an operation in the case in which the projector 20 executes start processing in the management system 1C.

In step S41, the processing device 220 provided in the projector 20 functions as the generation unit 222. The processing device 220 generates, based on operation of the user U, an inquiry request for inquiring propriety of a start of the projector 20. The processing device 220 functions as the communication control unit 223. The processing device 220 causes the communication device 260 to transmit the generated inquiry request to the management server 10.

The processing device 110 provided in the management server 10C functions as the acquisition unit 113. The processing device 110 causes the communication device 150 to receive, from the projector 20, an inquiry request including the device identification information DID for identifying the projector 20, the inquiry request inquiring propriety of a start of the projector 20, and acquires the inquiry request.

In step S42, the processing device 110 provided in the management server 10C operates as the management unit 111. The processing device 110 manages the management information AI stored in the management information database AD1. More specifically, as explained below, the processing device 110 sets the start propriety information OI included in the management information AI corresponding to the projector 20 at an acquisition source of the inquiry request.

In step S43, the processing device 110 provided in the management server 10C functions as the output unit 115. The processing device 110 outputs the start propriety information OI set in step S42. Specifically, the processing device 110 causes the communication device 150 to transmit an inquiry response including the start propriety information OI to the projector 20.

The processing device 220 provided in the projector 20 functions as the communication control unit 223. The processing device 220 causes the communication device 260 to receive the inquiry response including the start propriety information OI from the management server 10.

In step S44, the processing device 220 provided in the projector 20 functions as the start processing unit 224. The processing device 220 executes start processing concerning a start of the projector 20 based on the inquiry response received in step S43.

More specifically, when the start propriety information OI included in the inquiry response received in step S43 is “appropriate”, the processing device 220 executes the start processing of starting the projector 20. On the other hand, when the start propriety information OI included in the inquiry response received in step S43 is “inappropriate”, the processing device 220 does not execute the start processing of starting the projector 20. Alternatively, the processing device 220 suspends the start processing of starting the projector 20. Alternatively, the processing device 220 turns off the projector 20.

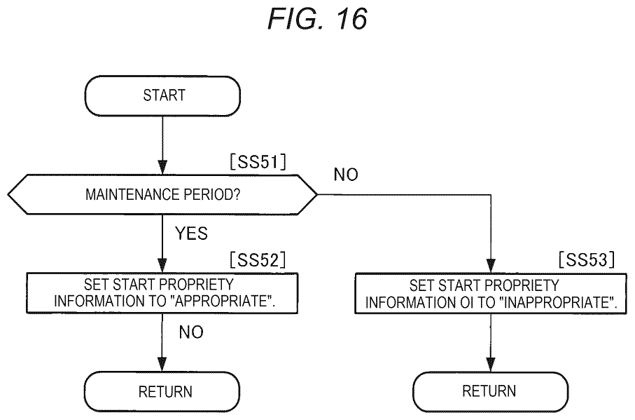

FIG. 16 is a flowchart illustrating sub-steps constituting step S42 in the present embodiment. Step S42 includes sub-steps SS51 to SS53.

In sub-step SS51, the processing device 110 provided in the management server 10C functions as the second determination unit 118. The processing device 110 determines whether the present point in time is within a maintenance period of the management server 10C. When it is determined that the present point in time is within the maintenance period of the management server 10C (“YES” in sub-step SS51), the processing device 110 executes processing in sub-step SS52. When it is determined that the present point in time is not within the maintenance period of the management server 10C (“NO” in sub-step SS51), the processing device 110 executes processing in sub-step SS53.

In sub-step SS52, the processing device 110 provided in the management server 10C functions as the management unit 111. The processing device 110 sets the start propriety information OI to “appropriate”.

In sub-step SS53, the processing device 110 provided in the management server 10C functions as the management unit 111. The processing device 110 sets the start propriety information OI to “inappropriate”.

### 5: Fifth Embodiment

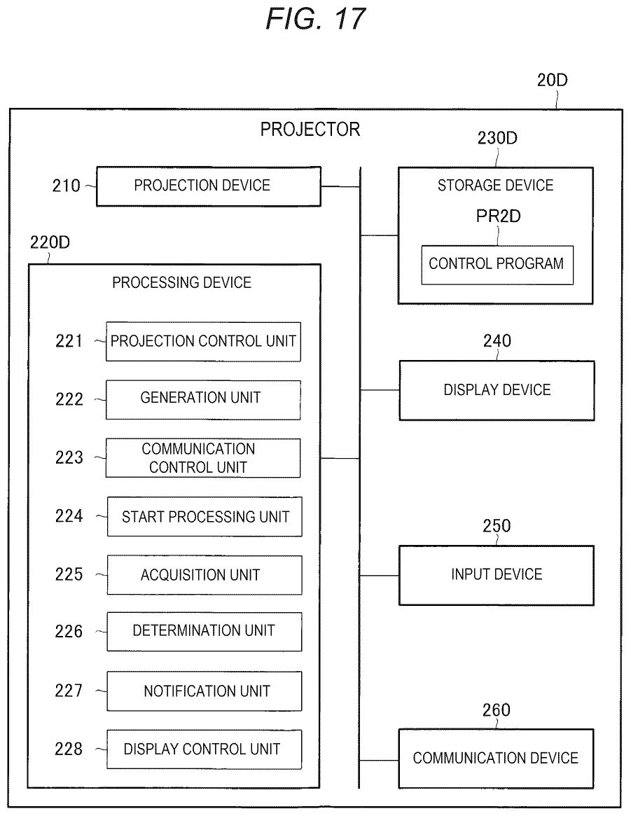

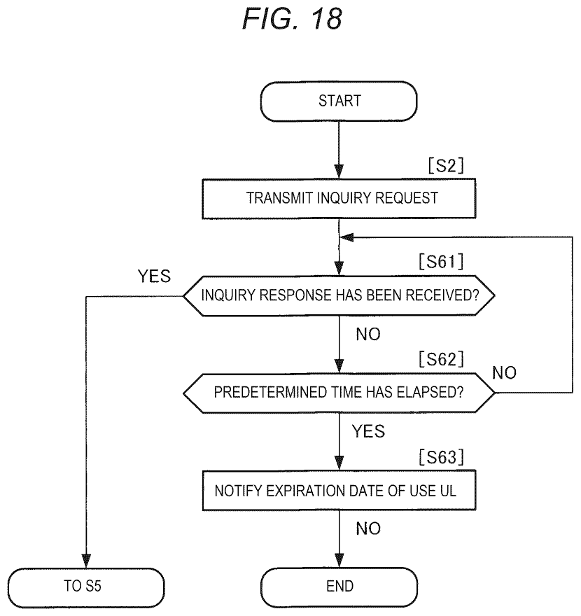

A management system 1D according to a fifth embodiment is explained below with reference to FIGS. 17 and 18. For simplification of explanation, in the following explanation, differences of the management system 1D according to the present embodiment from the management system 1 according to the first embodiment are mainly explained. Among the constituent elements provided in the management system 1D according to the present embodiment, the same constituent elements as the elements of the management system 1 according to the first embodiment are denoted by the same reference numerals and signs and explanation of functions of the element is sometimes omitted.

In the management system 1 according to the first embodiment, when the communication control unit 223 has not successfully caused the communication device 260 to receive, from the management server 10, the inquiry response transmitted from the management server 10, the start processing unit 224 does not start the projector 20. On the other hand, in the management system 1D according to the present embodiment, when the communication control unit 223 has not successfully caused the communication device 260 to receive, from the management server 10, the inquiry response transmitted from the management server 10, the start processing unit 224 starts the projector 20. Then, the projector 20 notifies an expiration date of use of the projector 20 to the user U.

### 5-1: Overall Configuration

Unlike the management system 1 according to the first embodiment, the management system 1D according to the present embodiment includes a projector 20D instead of the projector 20. Otherwise, an overall configuration of the management system 1A is the same as the overall configuration of the management system 1 illustrated in FIG. 1. Therefore, illustration of the overall configuration is omitted.

### 5-2: Configuration of the Projector

FIG. 17 is a block diagram illustrating a configuration of the projector 20D. Unlike the projector 20 according to the first embodiment, the projector 20D according to the present embodiment includes a processing device 220D instead of the processing device 220 and includes a storage device 230D instead of the storage device 230. The projector 20D according to the present embodiment includes a display device 240.

The storage device 230D stores a control program PR2D instead of the control program PR2 stored by the storage device 230 according to the first embodiment.

The display device 240 is a device that displays images and character information. The display device 240 displays various images under control by the processing device 220D. For example, various display panels such as a liquid crystal display panel and an organic EL (Electro Luminescence) display panel are suitably used as the display device 240.

When the input device 250 includes a touch panel, the input device 250 may also serve as the display device 240.

The processing device 220D functions as an acquisition unit 225, a determination unit 226, a notification unit 227, and a display control unit 228 in addition to the projection control unit 221, the generation unit 222, the communication control unit 223, and the start processing unit 224 by reading the control program PR2D from the storage device 230D and executing the control program PR2D. The control program PR2D may be transmitted from another device such as the management server 10 that manages the projector 20D via the communication network NET.

The acquisition unit 225 acquires an expiration date of use UL of the projector 20D from the management server 10. The acquisition unit 225 stores the acquired expiration date of use UL in the storage device 230D. The expiration date of use UL is an example of a “third expiration date of use”.

As explained above, in the management server 10 in the first embodiment, when the payment history information PI corresponding to each user U has been updated between the nearest payment due date in the past and the preceding payment due date, the management unit 111 sets the start propriety information OI corresponding to the user U to “1”. On the other hand, when the payment history information PI corresponding to each user U identified by the user identification information UID has not been updated between the nearest payment due date in the past and the preceding payment due date, the management unit 111 sets the start propriety information OI corresponding to the user U to “0”.

Therefore, when the start propriety information OI corresponding to the user U is set to “1”, the expiration date of use UL of the projector 20D used by the user U is the next payment expiration date. On the other hand, when the start propriety information OI corresponding to the user U is set to “0”, the expiration date of use UL of the projector 20D used by the user U is the first payment expiration date after a date when the user U paid the use fee last in the past.

The acquisition unit 225 acquires these expiration dates of use UL as the expiration dates of use UL of the projector 20D from the management server 10.

After the inquiry request for inquiring propriety of a start of the projector 20D has been transmitted to the management server 10, the determination unit 226 determines whether the communication control unit 223 has successfully caused the communication device 260 to receive the inquiry response from the management server 10.

When the determination unit 226 determines that the inquiry response has not been successfully received from the management server 10, the notification unit 227 notifies the expiration date of use UL of the projector 20D to the user U who uses the projector 20D.

For example, when the communication control unit 223 has not successfully caused the communication device 260 to receive the inquiry response from the management server 10 because a communication failure has occurred or because a network failure has occurred owing to the management server 10 in a maintenance period, the start processing unit 224 executes the start processing of starting the projector 20D. After the projector 20 is started by the start processing unit 224, the notification unit 227 notifies the expiration date of use UL of the projector 20 to the user U who uses the projector 20.

As an example, the notification unit 227 outputs the expiration date of use UL stored by the storage device 230D to the display control unit 228.

In this case, the display control unit 228 causes the display device 240 to display the expiration date of use UL of the projector 20D.

When the communication control unit 223 has not successfully caused the communication device 260 to receive the inquiry response from the management server 10, the projector 20D may be able to be used until the expiration date of use UL. Alternatively, when the communication control unit 223 has not successfully caused the communication device 260 to receive the inquiry response from the management server 10, the projector 20D may be unable to be normally used and unable to be used for other than network setting.

### 5-3: Operation of the Management System

Since an operation of the management system 1D is the same as the operation of the management system 1 illustrated in FIG. 6, illustration of the operation is omitted. However, in the operation of the management system 1D, unlike the operation of the management system 1, the projector 20D executes processing in step S61 between step S2 and step S5 as further processing. When a determination result in step S61 is affirmative, the projector 20D executes the processing in step S5 as in the operation of the management system 1. On the other hand, when the determination result in step S61 is negative, the projector 20D executes step S62 and step S63. FIG. 18 is a flowchart illustrating an operation of the projector 20D in the present embodiment.

In step S2, the processing device 220D provided in the projector 20D functions as the generation unit 222. The processing device 220D generates, based on operation of the user U, an inquiry request for inquiring propriety of a start of the projector 20D. The processing device 220D functions as the communication control unit 223. The processing device 220D causes the communication device 260 to transmit the generated inquiry request to the management server 10.

In step S61, the processing device 220D provided in the projector 20D functions as the determination unit 226. The processing device 220D determines whether the processing device 220D has successfully caused the communication device 260 to receive an inquiry response from the management server 10. When the processing device 220D has successfully caused the communication device 260 to receive the inquiry response (“YES” in step S61), the processing device 220D executes the processing in step S5. When the processing device 220D has not successfully caused the communication device 260 to receive the inquiry response (“NO” in step S61), the processing device 220D executes the processing in step S62.

In step S62, the processing device 220D provided in the projector 20D functions as the determination unit 226. When a predetermined time has elapsed after the processing device 220D executed the processing in step S2 (“YES” in step S62), the processing device 220D executes processing in step S63. When the predetermined time has not elapsed yet after the processing device 220D executed the processing in step S2 (“NO” in step S62), the processing device 220D executes the processing in step S61.

In step S63, the processing device 220D functions as the notification unit 227. The processing device 220D notifies the expiration date of use UL of the projector 20 to the user U who uses the projector 20.

### 6: Sixth Embodiment

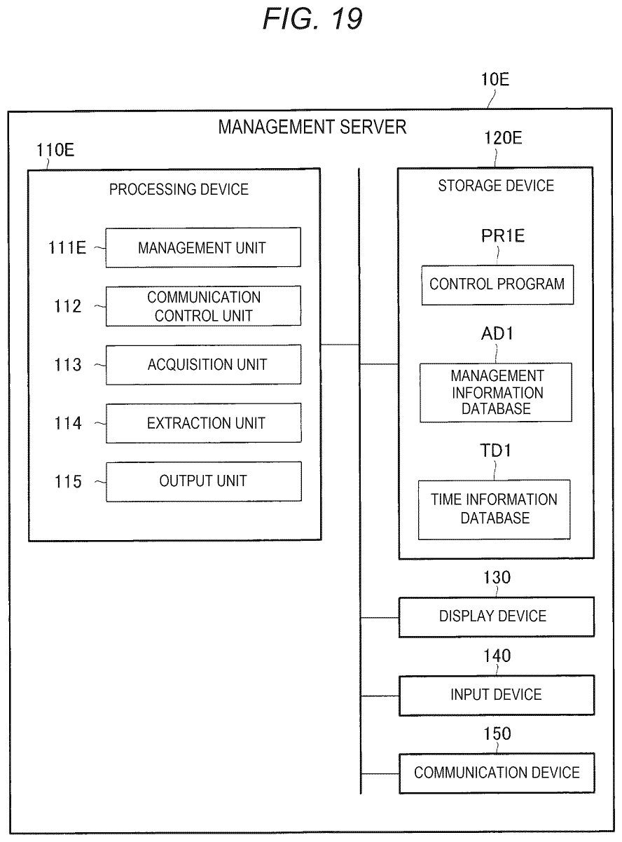

A management system 1E according to a sixth embodiment is explained below with reference to FIGS. 19 to 26. For simplification of explanation, in the following explanation, differences of the management system 1E according to the present embodiment from the management system 1 according to the first embodiment and the management system 1B according to the third embodiment are mainly explained. Among constituent elements provided in the management system 1E according to the present embodiment, the same constituent elements as the elements of the management system 1 according to the first embodiment and the management system 1B according to the third embodiment are denoted by the same reference numerals and signs and explanation of functions the elements is sometimes omitted.

The management system 1 according to the first embodiment manages, according to whether the payment history information PI has been updated between the nearest payment due date in the past and the preceding payment due date, the start propriety information OI indicating propriety of a start of the projector 20. On the other hand, the management system 1E according to the present embodiment manages the start propriety information OI indicating propriety of a start of the projector 20 based on a start possible time of the projector 20.

### 6-1: Overall Configuration

Unlike the management system 1B according to the third embodiment, the management system 1E according to the present embodiment includes a management server 10E instead of the management server 10, includes projectors 20E[1] to 20E[n] instead of the projectors 20[1] to 20[n], and includes an information management device 30E instead of the information management device 30. Otherwise, an overall configuration of the management system 1E is the same as the overall configuration of the management system 1B illustrated in FIG. 11. Therefore, illustration of the overall configuration is omitted.

### 6-2: Configuration of the Management Server

FIG. 19 is a block diagram illustrating a configuration example of the management server 10E. Unlike the management server 10, the management server 10E includes a processing device 110E instead of the processing device 110 and includes a storage device 120E instead of the storage device 120.

Unlike the storage device 120, the storage device 120E stores a control program PR1E instead of the control program PR1. The storage device 120E stores a time information database TD1 in addition to the management information database AD1 and instead of the history information database HD1.

The time information database TD1 is a database in which time information TI is stored. In the present embodiment, the time information TI is information that associates the user identification information UID for identifying each of the users U[1] to U[n] and a remaining time RT. The remaining time RT indicates a remaining amount of time in which each of the users U[1] to U[n] can start each of the projectors 20[1] to 20[n]. The remaining time RT in the present embodiment is an example of a “start possible time”.

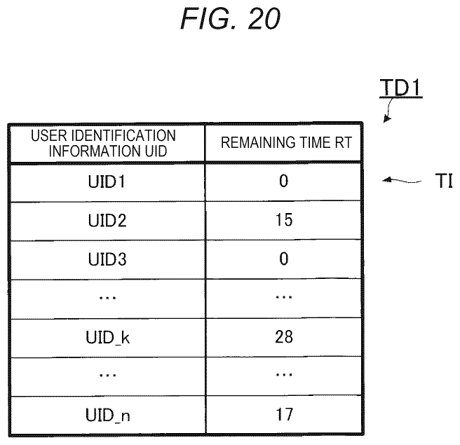

FIG. 20 is a diagram illustrating a configuration example of the time information database TD1. In the time information database TD1, the user identification information UID and the remaining time RT are stored as the time information TI in association with each other.

In the example illustrated in FIG. 20, as an example, the time information TI indicating that the remaining time RT in which the user U[k] whose user identification information UID is “UID_k” can use the projector 20[k] used by the user U[k] is twenty-eight hours is stored in the time information database TD1.

In FIG. 19, the processing device 110E functions as a management unit 111E, the communication control unit 112, the acquisition unit 113, the extraction unit 114, and the output unit 115 by reading the control program PR1E from the storage device 120E and executing the control program PR1E.

The management unit 111E manages, based on an update request received from each of the projector 20 and the information management device 30E, the time information TI stored in the time information database TD1. In the present embodiment, the management unit 111E updates the remaining time RT included in the time information TI based on the update request.

The management unit 111E manages the management information AI stored in the management information database AD1. In the present embodiment, the management unit 111 manages the management information AI based on the time information TI stored in the time information database TD1.

Specifically, in the time information database TD1, when the remaining time RT corresponding to each user U identified by the user identification information UID is larger than zero, the management unit 111E sets the start propriety information OI corresponding to the user U to “1”. On the other hand, when the remaining time RT corresponding to each user U identified by the user identification information UID is zero, the management unit 111E sets the start propriety information OI corresponding to the user U to “0”.

### 6-3: Configuration of the Projector

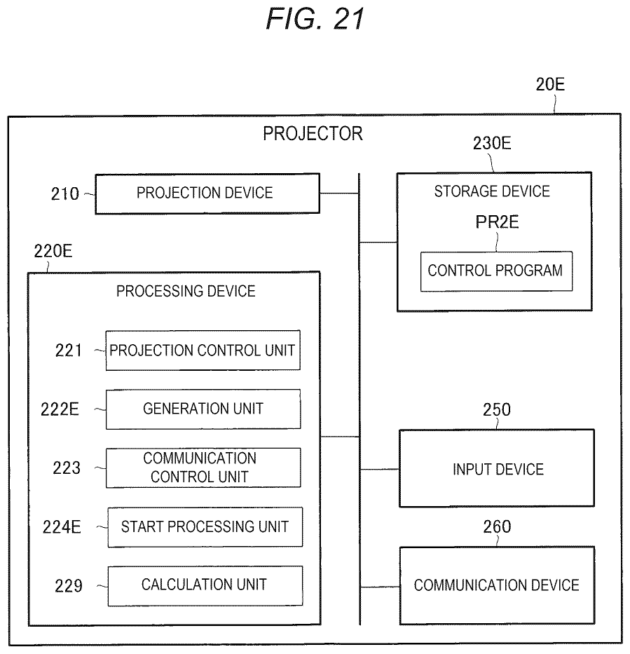

FIG. 21 is a block diagram illustrating a configuration example of the projector 20E. Unlike the projector 20, the projector 20E includes a processing device 220E instead of the processing device 220 and includes a storage device 230E instead of the storage device 230.

Unlike the storage device 230, the storage device 230E stores a control program PR2E instead of the control program PR2.

The processing device 220E functions as the projection control unit 221, a generation unit 222E, the communication control unit 223, a start processing unit 224E, and a calculation unit 229 by reading the control program PR2E from the storage device 230E and executing the control program PR2E. The control program PR2E may be transmitted from, via the communication network NET, another device such as the management server 10E that manages the projector 20E.

The start processing unit 224E has the same function as the function of the start processing unit 224 in the first embodiment. Furthermore, when the user U uses the input device 250 to generate an input signal for starting the projector 20, the start processing unit 224E detects the input signal. The start processing unit 224E causes, according to the detection of the input signal, the storage device 230E to store start time of the projector 20. When the user U uses the input device 250 to generate an input signal for turning off the projector 20, the start processing unit 224E detects the input signal. The start processing unit 224 causes, according to the detection of the input signal, the storage device 230E to store an end time of the projector 20.

The calculation unit 229 calculates a use time of the projector 20 from the difference between the start time and the end time stored in the storage device 230E.

When the use time explained above is calculated by the calculation unit 229, the generation unit 222E generates an update request including the device identification information DID of the projector 20E and for requesting the management server 10E to update the remaining time RT stored in the time information database TD1. More specifically, the generation unit 222E generates an update request for requesting the management server 10E to subtract the use time calculated by the calculation unit 229 from the remaining time RT stored in the time information database TD1. The update request generated by the generation unit 222E is transmitted to the management server 10E by the communication control unit 223.

### 6-4: Configuration of the Information Management Device

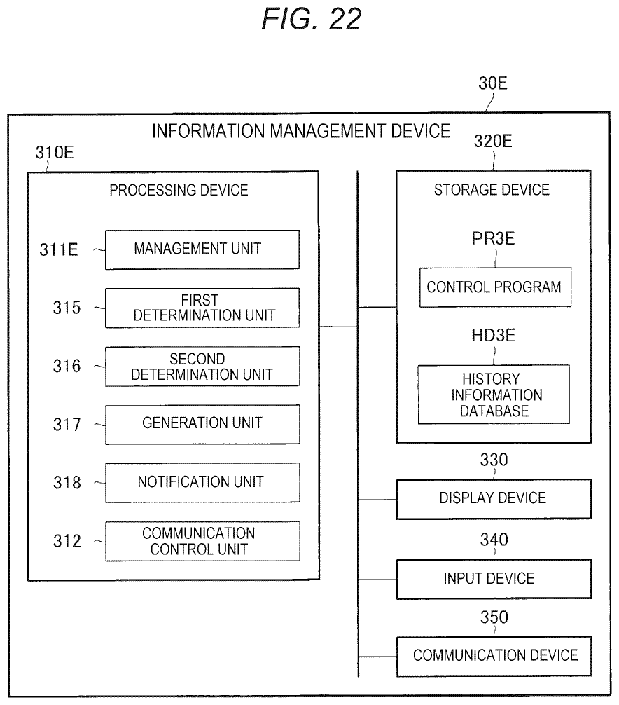

FIG. 22 is a block diagram illustrating a configuration example of the information management device 30E. Unlike the information management device 30, the information management device 30E includes a processing device 310E instead of the processing device 310 and includes a storage device 320E instead of the storage device 320.

Unlike the storage device 320, the storage device 320E stores a control program PR3E instead of the control program PR3. The storage device 320E stores a history information database HD3E instead of the history information database HD3.

The history information database HD3E is a database in which purchase history information BI indicating a history of the user U purchasing a ticket for using the projector 20 is stored. In the present embodiment, the “ticket” is a ticket for acquiring a use time of the projector 20. The ticket can be purchased through, for example, a website. Alternatively, the user U[k] can automatically acquire the ticket by coming into a monetary contract with a management corporation that manages the projector 20[k]. As an example, the ticket is a ticket to be purchased by the user U[k] in order to acquire a unit use time of 100 hours as a use time of the projector 20[k]. However, the ticket is not limited to the ticket for purchasing the use time of 100 hours. A plurality of types of tickets corresponding to use times different from one another such as 500 hours and 1000 hours may be sold. For simplification of explanation, the following explanation is based on the premise that only the ticket for the use time of 100 hours is sold.

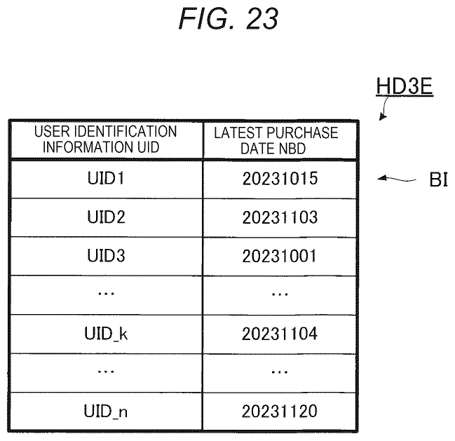

FIG. 23 is a diagram illustrating a configuration example of the history information database HD3E. In the history information database HD3E, the user identification information UID and a latest purchase date NBD are stored as the purchase history information BI in association with each other.

In the example illustrated in FIG. 23, as an example, the purchase history information BI indicating that the latest purchase date NBD of the ticket by the user U[k] whose user identification information UID is “UID_k” is Nov. 4, 2023 is stored in the history information database HD3E.

In FIG. 22, the processing device 310E functions as a management unit 311E, a communication control unit 312, a first determination unit 315, a second determination unit 316, a generation unit 317, and a notification unit 318 by reading the control program PR3E from the storage device 320E and executing the control program PR3E.

The management unit 311E manages the purchase history information BI stored in the history information database HD3E. Specifically, when each of the users U[1] to U[n] purchases a ticket, the management unit 311E updates a value of the latest purchase date NBD included in the purchase history information BI to a value indicating a date of the latest purchase date.

The first determination unit 315 determines whether the present point in time is an update confirmation date for confirming the update of the purchase history information BI.

When the first determination unit 315 determines that the present point in time is the update confirmation date, the second determination unit 316 determines whether the purchase history information BI has been updated between the last update confirmation date and the current update confirmation date.

When the second determination unit 316 determines that the purchase history information BI has been updated, the generation unit 317 generates an update request including the user identification information UID and for requesting the management server 10E to update the remaining time RT and stored in the time information database TD1. More specifically, the generation unit 317 generates an update request for requesting the management server 10E to add a use time for a ticket purchased by the user U to the remaining time RT stored in the time information database TD1. The update request generated by the generation unit 317 is transmitted to the management server 10E by the communication control unit 312.

When it is not determined that the purchase history information BI has been updated, the notification unit 318 notifies the user U that the remaining time RT is zero or the remaining time RT is short. For example, the notification unit 318 causes the communication device 350 to transmit a message indicating that the remaining time RT is zero or the remaining time RT is short to a not-illustrated terminal device owned by the user U.

### 6-5: Operation of the Management System

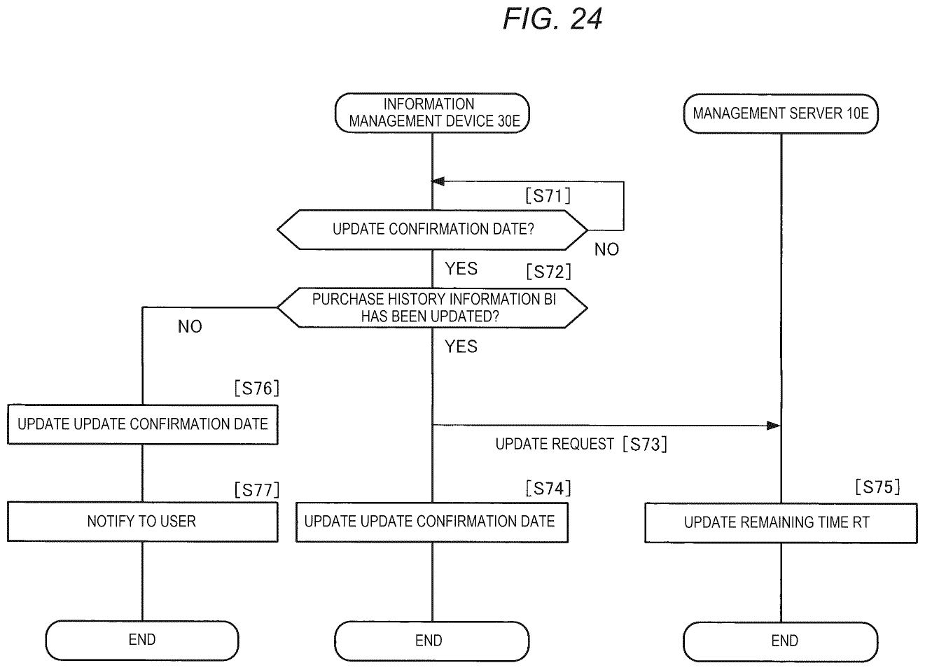

FIGS. 24 to 26 are sequence diagrams illustrating an operation of the management system 1E.

FIG. 24 is a sequence diagram illustrating an operation of the management server 10E updating, based on an update request received from the information management device 30E, the remaining time RT stored in the time information database TD1.

In step S71, the processing device 310E provided in the information management device 30E functions as the first determination unit 315. The processing device 310E determines whether the present point in time is an update confirmation date for confirming update of the purchase history information BI. When the present point in time is the update confirmation date (“YES” in step S71), the processing device 310E executes processing in step S72. When the present point in time is not the update confirmation date (“NO” in step S71), the processing device 310E executes processing in step S71.

In step S72, the processing device 310E provided in the information management device 30E functions as the second determination unit 316. The processing device 310E determines whether the purchase history information BI of each user U has been updated in the history information database HD3E between the last update confirmation date and the current update confirmation date. When the purchase history information BI has been updated (“YES” in step S72), the processing device 310E executes processing in step S73. When the purchase history information BI has not been updated (“NO” in step S72), the processing device 310E executes processing in step S76.

In step S73, the processing device 310E provided in the information management device 30E functions as the generation unit 317. The processing device 310E generates an update request for requesting the management server 10E to update the remaining time RT stored in the time information database TD1. The update request requests to add a use time of a purchased ticket to the remaining time RT. The processing device 310E functions as the communication control unit 312. The processing device 310E causes the communication device 350 to transmit the generated update request to the management server 10E.

The processing device 110E provided in the management server 10E functions as the communication control unit 112. The processing device 110E causes the communication device 150 to receive the update request from the information management device 30E.

In step S74, the processing device 310E provided in the information management device 30E functions as the management unit 311E. The processing device 310E updates the update confirmation date to the next update confirmation date.

In step S75, the processing device 110E provided in the management server 10E functions as the management unit 111E. The processing device 110E updates the remaining time RT stored in the time information database TD1.

In step S76, the processing device 310E provided in the information management device 30E functions as the management unit 311E. The processing device 310E updates the update confirmation date to the next update confirmation date.

In step S77, the processing device 310E provided in the information management device 30E functions as the notification unit 318. The processing device 310E notifies the user U that the remaining time RT is zero or the remaining time RT is short.

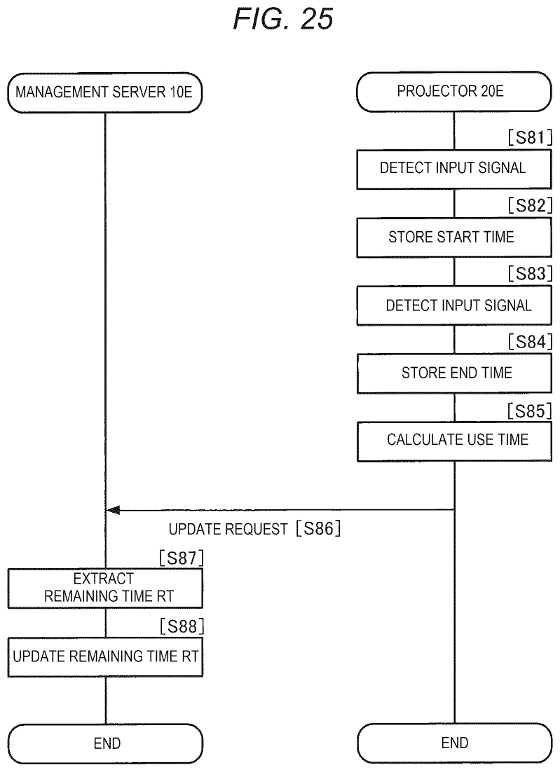

FIG. 25 is a sequence diagram illustrating an operation of the management server 10E updating, using a use time of the projector 20E, the remaining time RT stored in the time information database TD1.

In step S81, the processing device 220E provided in the projector 20E functions as the start processing unit 224E. The processing device 220E detects an input signal for starting the projector 20E generated by the user U using the input device 250.

In step S82, the processing device 220E provided in the projector 20E functions as the start processing unit 224E. The processing device 220E causes the storage device 230 to store start time of the projector 20E.

In step S83, the processing device 220E provided in the projector 20E functions as the start processing unit 224E. The processing device 220E detects an input signal for turning off the projector 20E generated by the user U using the input device 250.

In step S84, the processing device 220E provided in the projector 20E functions as the start processing unit 224E. The processing device 220E causes the storage device 230E to store end time of the projector 20E.

In step S85, the processing device 220E provided in the projector 20E functions as the calculation unit 229. The processing device 220E calculates a use time of the projector 20E from the difference between the start time and the end time stored in the storage device 230E.

In step S86, the processing device 220E provided in the projector 20E functions as the generation unit 222E. The processing device 220E generates an update request including the device identification information DID of the projector 20E and for requesting the management server 10E to update the remaining time RT stored in the time information database TD1. The update request requests to subtract the use time of the projector 20E from the remaining time RT. The processing device 220E functions as the communication control unit 223. The processing device 220E causes the communication device 260 to transmit the generated update request to the management server 10E.

The processing device 110E provided in the management server 10E functions as the communication control unit 112. The processing device 110E causes the communication device 150 to receive the update request from the projector 20E.

In step S87, the processing device 110E provided in the management server 10E functions as the management unit 111E. The processing device 110E extracts the user identification information UID corresponding to the device identification information DID by referring to the management information database AD1 using the device identification information DID included in the update request received in step S86. Further, the processing device 110E extracts the remaining time RT corresponding to the user identification information UID by referring to the time information database TD1 using the extracted user identification information UID.

In step S88, the processing device 110E provided in the management server 10E functions as the management unit 111E. The processing device 110E updates, based on the update request received in step S86, the remaining time RT extracted in step S87.

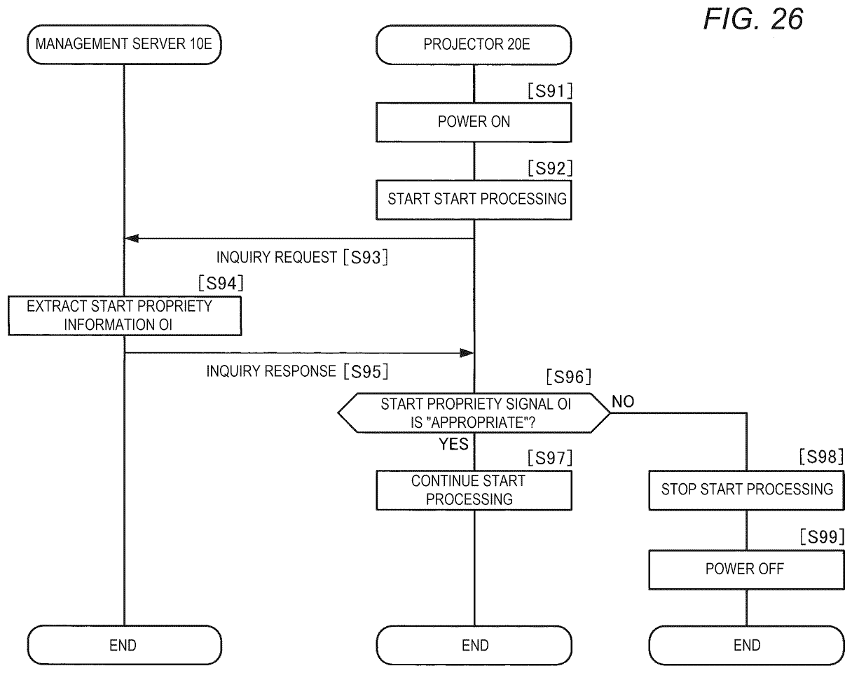

FIG. 26 is a sequence diagram illustrating an operation in the case in which the projector 20E executes start processing.

In step S91, the processing device 220E provided in the projector 20E functions as the start processing unit 224E. The processing device 220E detects an input signal for starting the projector 20E generated by the user U using the input device 250.

In step S92, the processing device 220E provided in the projector 20E functions as the start processing unit 224E. The processing device 220E starts start processing of starting the projector 20E.

In step S93, the processing device 220E provided in the projector 20E functions as the generation unit 222E. The processing device 220E generates, based on operation of the user U, an inquiry request for inquiring propriety of a start of the projector 20E. The processing device 220E functions as the communication control unit 223. The processing device 220E causes the communication device 260 to transmit the generated inquiry request to the management server 10E.

The processing device 110E provided in the management server 10E functions as the acquisition unit 113. The processing device 110E causes the communication device 150 to receive an inquiry request including the device identification information DID for identifying the projector 20E, the inquiry request inquiring propriety of a start of the projector 20E, from the projector 20E and acquires the inquiry request.

In step S94, the processing device 110E provided in the management server 10E functions as the extraction unit 114. The processing device 110E refers to the management information AI stored in the management information database AD1 and extracts the start propriety information OI corresponding to the device identification information DID included in the inquiry request acquired in step S93.

In step S95, the processing device 110E provided in the management server 10E functions as the output unit 115. The processing device 110E outputs the start propriety information OI extracted in step S94. Specifically, the processing device 110E causes the communication device 150 to transmit an inquiry response including the start propriety information OI to the projector 20E.

The processing device 220E provided in the projector 20E functions as the communication control unit 223. The processing device 220E causes the communication device 260 to receive the inquiry response including the start propriety information OI from the management server 10E.

In step S96, the processing device 220E provided in the projector 20E functions as the start processing unit 224E. The processing device 220E determines whether the start propriety information OI included in the inquiry response received in step S95 is “appropriate” or “inappropriate”. When the start propriety information OI is “appropriate” (“YES” in step S96), the processing device 220E executes processing in step S97. When the start propriety information OI is “inappropriate” (“NO” in step S96), the processing device 220E executes processing in step S98.

In step S97, the processing device 220E provided in the projector 20E functions as the start processing unit 224E. The processing device 220E continues the start processing.

In step S98, the processing device 220E provided in the projector 20E functions as the start processing unit 224E. The processing device 220E stops the start processing.

In step 599, the processing device 220E turns off the projector 20E.

### 7: Modifications

The embodiments explained above can be variously modified. Specific aspects of modifications are exemplified below. The aspects exemplified below and the aspects explained in the embodiments explained above can be combined as appropriate within a range in which the aspects do not contradict each other. In the modifications exemplified below, for elements having action and functions equivalent to those in the embodiments, the reference numerals and signs referred to in the above explanation are used and detailed explanation of the individual elements is omitted as appropriate.

### 7-1: Modification 1

In the management system 1 according to the first embodiment, the output unit 115 provided in the management server 10 outputs the start propriety information OI to the communication control unit 112 and the communication control unit 112 causes the communication device 150 to transmit, to any one of the projectors 20[1] to 20[n], the start propriety information OI output from the output unit 115. However, the communication control unit 112 may cause the communication device 150 to transmit the start propriety information OI to a terminal apparatus (not illustrated) used by each user.

### 7-2: Modification 2

In the management system 1B according to the third embodiment, the management server 10 transmits an inquiry request, which is a request for inquiring the payment history information PI, to the information management device 30 and the information management device 30 transmits an inquiry response including the payment history information PI to the management server 10. Then, the management server 10 manages, based on the payment history information PI received from the information management device 30, the management information AI stored in the management information database AD1.

However, the information management device 30 may generate, based on the payment history information PI stored in the history information database HD3, an update request for updating the start propriety information OI stored in the management information database AD1 of the management server 10 and transmit the update request to the management server 10. In this case, the management server 10 manages, based on the update request received from the information management device 30, the start propriety information OI stored in the management information database AD1.

### 7-3: Modification 3

In the management system 1D according to the fifth embodiment, the display control unit 228 provided in the projector 20D causes the display device 240 to display the expiration date of use UL of the projector 20D. However, the projection control unit 221 provided in the projector 20 may cause the projection device 210 to project the expiration date of use UL onto a screen.

Alternatively, the notification unit 227 provided in the projector 20D may cause the communication device 260 to transmit the expiration date of use UL to a terminal device used by the user U.

### 7-4: Modification 4

The management system 1E according to the sixth embodiment uses, as the start possible time of each projector 20, the remaining time RT that is the remaining amount of the time in which the user U[k] can start the projector 20[k]. Further, the management system 1E manages, based on the remaining time RT, the start propriety information OI indicating propriety of a start of the projector 20[k]. When the user U[k] purchases a ticket, a use time for the ticket is added to the remaining time RT. On the other hand, when the user U[k] uses the projector 20[k], a use time of the projector 20[k] is subtracted from the remaining time RT.

However, every time the user U[k] purchases a ticket, the start possible time of the projector 20[k] may be accumulated and, every time the user U[k] uses the projector 20[k], a total use time of the projector 20[k] may be accumulated. In this case, the management server 10E sets the start propriety information OI to “appropriate” when the start possible time exceeds the total use time and sets the start propriety information OI to “unavailable” when the difference between the start possible time and the total use time is zero.

### 8: Summary of the Present Disclosure

A summary of the present disclosure is appended below.

(Appendix 1) A management server including: a management unit configured to manage, for each of one or more projectors, first management information for associating device identification information for identifying the projector and start propriety information indicating propriety of a start of the projector; an acquisition unit configured to acquire, from a first projector, a first inquiry request including the device identification information for identifying the first projector, the first inquiry request inquiring propriety of a start of the first projector; an extraction unit configured to extract, referring to the first management information, start propriety information corresponding to the device identification information included in the first inquiry request; and an output unit configured to output the start propriety information indicating the propriety of the start of the first projector extracted by the extraction unit.

Accordingly, it is possible to determine propriety of a start of the projector 20 on the management server 10 side.

When the related art for determining propriety of a start on the projector 20 side is used, for example, if a use fee of the projector 20 is changed during a period in which a management company of the projector 20 lends out the projector 20, it is necessary for a serviceperson of the company to go to an installation place of the projector 20 and change a determination condition for start propriety of the projector 20. In the aspect of the present disclosure, since propriety of a start of the projector 20 can be determined on the management server 10 side, it is possible to prevent a load on the management side from increasing even when the determination condition for the start propriety is changed. Specifically, in the aspect of the present disclosure, it is unnecessary for the serviceperson to go to the installation place of the projector 20. As a result, the management system 1 can reduce the necessity of operation cost and manpower of the serviceperson.

(Appendix 2) The management server described in the appendix 1, in which the management unit manages the start propriety information based on payment history information that is a history of fees that one or more users who use the one or more projectors paid in order to use the one or more projectors.

Accordingly, when payment from the user U is delayed, it is possible to determine the start propriety of the projector 20 on the management server 10 side.

(Appendix 3) The management server described in the appendix 1, in which the management unit manages the start propriety information based on time information indicating a start possible time that is a time length in which one or more users who use the one or more projectors can start the one or more projectors.

Accordingly, when the use fee of the projector 20 is a time charge and payment of the use fee from the user U is delayed, it is possible to determine the start propriety of the projector 20 on the management server 10 side.

(Appendix 4) A management system including: the management server described in the appendix 1; and the first projector, in which the first projector includes: a generation unit configured to generate the first inquiry request based on operation of a user of the first projector; a communication control unit configured to transmit the first inquiry request to the management server and receive a first inquiry response including the start propriety information from the management server; and a start processing unit configured to execute start processing concerning a start of the first projector based on the first inquiry response received by the communication control unit.

Accordingly, it is possible to determine propriety of a start of the projector 20 on the management server 10 side.

(Appendix 5) The management system described in the appendix 4, in which, when the communication control unit did not successfully transmit the first inquiry request to the management server, the start processing unit brings a content projection function of the first projector into an unusable state.

Accordingly, when the projector 20 is not connected to a network, the management server 10 is capable of not starting the projector 20.

(Appendix 6) The management system described in the appendix 4, in which, when the communication control unit did not successfully receive the first inquiry response from the management server, the start processing unit brings a content projection function of the first projector into an unusable state.

Accordingly, when the projector 20 is not connected to a network, the management server 10 is capable of not starting the projector 20.

(Appendix 7) The management server described in the appendix 2, further including: a setting unit configured to set a first expiration date of use of the one or more projectors; and a first determination unit configured to determine whether a present point in time passed the first expiration date of use, in which, when the first determination unit determines that the present point in time passed the first expiration date of use of the first projector, the setting unit sets a second expiration date of use later than the first expiration date of use according to the payment history information, and the management unit manages, based on the second expiration date of use of the first projector, start propriety information corresponding to the first projector.

Accordingly, even when payment of a use fee of the projector 20 by the user U is delayed, by setting a grace period, the user U is enabled to continuously use the projector 20.

(Appendix 8) A management system including: the management server described in the appendix 2; and an information management device configured to manage information concerning the one or more users, in which the payment history information includes user identification information for identifying the one or more users, and the information management device includes: a management unit configured to manage the payment history information for each of one or more projectors; an acquisition unit configured to acquire, from the management server, a second inquiry request including the user identification information for identifying a user of the first projector, the second inquiry request inquiring the payment history information corresponding to the user of the first projector; an extraction unit configured to extract the payment history information corresponding to the user of the first projector by referring to the payment history information managed by the management unit using the user identification information for identifying the user of the first projector; and a communication control unit configured to transmit, to the management server, a second inquiry response including the payment history information corresponding to the user of the first projector extracted by the extraction unit.

Accordingly, since the payment history information PI is managed by the information management device 30, a company different from the user U who manages the projector 20 can manage the payment history information PI.

(Appendix 9) The management server described in the appendix 1, further including a second determination unit configured to determine whether a present point in time is within a maintenance period of the management server, in which when the second determination unit determines that the present point in time is within the maintenance period, the management unit associates the device identification information of the first projector and start propriety information indicating that propriety of a start of the first projector is appropriate.

Accordingly, the user U can use the projector 20 even if the management server 10C is in the maintenance period.

(Appendix 10) The management system described in the appendix 4, in which the first projector further includes a notification unit configured to notify a third expiration date of use of the first projector to the user of the first projector and, when the communication control unit did not successfully receive the first inquiry response from the management server, the start processing unit starts the first projector, and the notification unit notifies the third expiration date of use to the user of the first projector.

Accordingly, even when the projector 20D has failed in connection to the management server 10 because of a network failure, the user U can use the projector 20D for a predetermined period.

(Appendix 11) The management system described in the appendix 10, in which the first projector further includes: a display device; and a display control unit configured to cause the display device to display the third expiration date of use.

Accordingly, since the expiration date of use of the projector 20D is displayed on the display device 240, the user U can learn a due date when the projector 20D becomes unable to be started.

What is claimed is:

1. A management server executes
managing a first management information for each of one or more projectors,
acquiring a first inquiry request inquiring propriety of a start of the first projector from the first projector,
extracting, referring to the first management information, start propriety information corresponding to a device identification information included in the first inquiry request, and
outputting the start propriety information indicating the propriety of the start of the first projector,
wherein the first management information associates the device identification information to identify the projector with the start propriety information.

2. The management server according to claim 1, further executes managing the start propriety information based on payment history information that is a history of fees that one or more users who use the one or more projectors paid in order to use the one or more projectors.

3. The management server according to claim 1, further executes managing the start propriety information based on time information indicating a start possible time that is a time length in which one or more users who use the one or more projectors can start the one or more projectors.

4. A management system comprising:
the management server according to claim 1; and
the first projector, wherein
the first projector executes
generating the first inquiry request based on operation of a user of the first projector;
transmitting the first inquiry request to the management server;
receiving a first inquiry response including the start propriety information from the management server; and
processing a start procedure of the first projector based on the first inquiry response.

5. The management system according to claim 4, wherein the first projector starts into an unusable state that is state limited a content projection function, when transmitting the first inquiry request to the management server did not success.

6. The management system according to claim 4, wherein the first projector starts into an unusable state that is state limited a content projection function, when receiving the first inquiry response from the management server did not success.

7. The management server according to claim 2, further comprising:
setting a first expiration date of use of the one or more projectors; and
determining whether a present point in time passed the first expiration date of use, wherein
setting a second expiration date of use later than the first expiration date of use according to the payment history information, and managing the start propriety information corresponding to the first projector, based on the second expiration date of use of the first projector, when the present point in time passed the first expiration date of use of the first projector.

8. A management system comprising:
the management server according to claim 2; and
an information management device configured to manage information concerning the one or more users, wherein
the payment history information includes user identification information for identifying the one or more users, and
the information management device executes
managing the payment history information for each of one or more projectors;
acquiring, from the management server, a second inquiry request including the user identification information for identifying a user of the first projector, the second inquiry request inquiring the payment history information corresponding to the user of the first projector;
extracting the payment history information corresponding to the user of the first projector by referring to the payment history information managed by the management unit using the user identification information for identifying the user of the first projector; and
transmitting, to the management server, a second inquiry response including the payment history information corresponding to the user of the first projector extracted by the extraction unit.

9. The management server according to claim 1, further executes determining whether a present point in time is within a maintenance period of the management server, wherein
the management server associates the device identification information of the first projector and start propriety information indicating that propriety of a start of the first projector is appropriate, when the present point in time is within the maintenance period.

10. The management system according to claim 4, wherein
the first projector processes the start procedure of the first projector and notifies a third expiration date of use of the first projector to the user of the first projector, when receiving receive the first inquiry response from the management server did not success.

11. The management system according to claim 10, wherein the first projector further includes:
a display device; and
a display controller configured to cause the display device to display the third expiration date of use.
